(19) United States
(12) Patent Application Publication
(10) Pub. No.: US 2019/0016095 A1
(43) Pub. Date: Jan. 17, 2019

(54) LAMINATED VEHICLE GLAZING WITH AMOLED SCREEN

(71) Applicant: SAINT-GOBAIN GLASS FRANCE, Courbevoie (FR)

(72) Inventors: Michael LABROT, Aachen (DE); Volkmar OFFERMANN, Eschweiler (DE); Bernhard REUL, Herzogenrath (DE)

(21) Appl. No.: 16/067,470

(22) PCT Filed: Dec. 22, 2016
(86) PCT No.: PCT/FR2016/053642

§ 371 Date: Jun. 29, 2018

(30) Foreign Application Priority Data
Dec. 31, 2015 (FR) 1563483

(51) Int. Cl. B32B 17/10; B60R 1/00

(52) U.S. Cl. CPC B32B 17/10036; B32B 17/10541; B60R 1/001; B32B 17/10174; B32B 17/10761

(57) ABSTRACT

A laminated vehicle glazing includes within the laminate an AMOLED screen and with, in the laminate or on face F4 of the second glazing of the laminate, an electroconducting structure including a tactile control zone, forming a switch of the AMOLED screen and/or navigation element(s) of the AMOLED screen.

The invention relates to a laminated vehicle glazing and more particularly a laminated vehicle glazing integrating an AMOLED screen. An ever greater number of intelligent windshields exist which deliver information to the driver.

Document W02015041106 proposes in particular an automobile windshield comprising an AMOLED (Active Matrix Organic Light Emitting Diode) screen—between the internal faces of the two glazings, screen arranged peripherally and masked in the enameled boundary on face F2 that is to say the internal face of the outermost glazing. The horizontally positioned AMOLED screen is aimed at replacing the internal rear view mirror to see the rear of the vehicle—conventionally in the form of a mirror—and is preferentially situated in the central part along the top longitudinal edge of the windshield. It is coupled with a camera at the rear of the vehicle.

The aim of the invention is to improve this laminated vehicle glazing with AMOLED screen notably windshield with AMOLED screen.

For this purpose, the subject of the present invention is a laminated vehicle glazing notably windshield or lateral glazing of a vehicle notably a road vehicle, comprising:
a first glazing, preferably cambered, preferably of mineral glass, preferably tinted, notably gray or green, with a first main face termed F1 intended to be on the outside of the vehicle and a second opposite main face termed F2, glazing of thickness E1 preferably (especially in the road sector, for an automobile) of at most 2.5 mm, even of at most 2 mm—notably 1.9 mm, 1.8 mm, 1.6 mm and 1.4mm—or even of at most 1.3 mm or of at most 1 mm,
a lamination interlayer of polymeric substance (clear, extraclear), preferably thermoplastic, on the face F2 side, of (total) thickness E2 preferably especially in the road sector, for an automobile) of at most 2.2 mm better of at most 2 mm, of at most 1.5 mm or even of at most 0.76 mm, for example composed of several plies for example 3 plies, notably set back from the lip of the second glazing (by at most 5 mm or even by at most 2 mm or by at most 1 mm)
a second glazing, preferably cambered (like the first glazing), preferably of mineral glass, with a third main face termed F3 on the lamination interlayer side and a fourth opposite main face termed F4, notably intended to be on the inside of the vehicle, optionally tinted (or clear and even with an electroconducting layer on face F3), of thickness E′1 preferably less than E1, even of at most 2.2 mm (especially in the road sector, for an automobile)—notably 1.9 mm, 1.8 mm, 1.6 mm and 1.4 mm—or even of at most 1.3 mm or of at most 1 mm, the total thickness of the glazings E1+E′1 being preferably (especially in the road sector, for an automobile) strictly less than 4.4 mm, even than 3.7 mm, one at least—and better both—of the first and second glazings being made of glass, the other optionally of organic, polymeric substance such as a polycarbonate,
between the face F2 and the face F3, a first organic light-emitting diode-based viewing screen termed a flexible AMOLED screen 3, comprising a set of pixels, the first AMOLED screen comprising a (central) zone of dynamic information display,—the AMOLED screen comprising a first flexible support (glass polymeric substance, or indeed even metal) bearing organic light-emitting system(s) between two electrodes—and AMOLED screen of thickness E3 less than E2 preferably subcentimetric and even of at most 0.5 mm, AMOLED screen having a front main face oriented toward F3 and a rear main face oriented toward F2,—the AMOLED screen being covered by a non-zero thickness of lamination interlayer—and preferably within the lamination interlayer—therefore with a non-zero thickness E21 of lamination interlayer between the rear face and F2 and/or with a non-zero thickness E22 between the front face and F3, E2 corresponding to the thickness on the side of the AMOLED screen (notably E2>than E21+E22 and substantially equal to E3), the AMOLED screen is notably arranged peripherally,
preferably an electrical connection element 4 of the AMOLED screen, with a so—called connecting part between the face F2 and the face F3, of thickness E4 less than E2 and preferably subcentimetric, with a front surface on the face F3 side and a rear surface on the face F2 side, connecting part covered by a non-zero thickness of lamination interlayer and even preferably connecting part within the lamination interlayer (like the AMOLED screen) with a non-zero thickness E41 of lamination interlayer between the rear surface and the face F2 and with a non-zero thickness E42 (preferably identical to the thickness E3) between the front surface and the face F3).

The connecting part is linked (preferably permanent link) to the AMOLED screen and extends (directly) the AMOLED screen in the direction of the lip of the second glazing, and the flexible electrical connection element extending outside of the lip of the second glazing (via a so-called exterior part).

The connection element in particular is for the power supply and (preferably)/or transporting data signals (simultaneously or sequentially) in particular electrical connection element comprising one or more power supply tracks (or “supply lines”) and/or one or more tracks for the data signals (or “data lines”), and electronic components (optionally in particular in the connecting part).

According to the invention, the laminated glazing comprises an electroconducting structure comprising a tactile control zone, forming a switch of the AMOLED screen and/or navigation element(s) of the AMOLED screen, tactile control zone linked to a power supply zone, notably in one and the same plane, made of one and the same substance, and of the same type: layer or wire), the tactile control zone (and preferably also the power supply zone) being between the face F2 and the face F3, covered by a non-zero thickness of lamination interlayer and preferably within the laminated glazing notably of thickness E6 less than E2 or being on the face F4.

In one embodiment, the tactile control zone is in proximity to the OLED screen (less than 3 cm from the edges), and the tactile control zone is transparent and in a transparent zone of the glazing (clear window region, notably restricted zone B or more peripheral zone), or else the tactile control zone is transparent or opaque, between the face F2 and the face F3, optionally masked from the interior by an interior masking layer on face F3 or face F4 and preferably endowed with a marker-forming opening (or several) of said tactile control zone (notably of the switch, of navigation element(s)).

In one embodiment, the tactile control zone is arranged:
for an upper or lower longitudinal reference edge, on one side of the AMOLED screen and preferably another tactile control zone of said AMOLED screen is on another side for example the opposite side,
or for an upper longitudinal reference edge, under a lower edge of the AMOLED screen or for a lower longitudinal reference edge above an upper edge of the AMOLED screen, and optionally with a power supply zone between the face F2 and the rear face of the AMOLED screen (slightly transparent or opaque and in front of an external masking layer) and even between the rear surface of the connecting part.

The tactile control zone can be in proximity to the AMOLED screen (less than 3 cm from the closest edge of the screen) or sited away from the AMOLED screen notably on an edge of the glazing distinct from the reference edge: in particular a lateral edge if the reference edge is the longitudinal edge.

The tactile control zone can be stretched along the reference edge (including opposite the front face of the OLED screen if transparent) or on an edge distinct from the reference edge or even in any zone of the clear window region.

The tactile control zone is on the front face side of the AMOLED screen, on or in the AMOLED screen, in particular the tactile control zone is an electroconducting zone on a flexible support notably transparent and polymeric (PET etc) which can be:
added to the AMOLED screen
or form part of the AMOLED screen notably lateral part of the substrate (extension of a technical edge) of the AMOLED screen or another film of the AMOLED screen, the flexible support optionally serving as protection of the organic light-emitting system and of the electrodes flanking it.

And optionally the power supply zone of the tactile control zone is on or in the electrical connection element. And in particular the power supply zone of the tactile control zone can be an electroconducting zone on a flexible support notably transparent and polymeric (PET etc) which can be:
added to the electrical connection element or
or form part of the electrical connection element notably on a film of the electrical connection element serving optionally also as protection of the electrical connection element.

The tactile control zone (as well as the power supply zone) can comprise one or more electroconducting wires (sheathed or not by a dielectric substance) optionally in or on a flexible support notably transparent and polymeric (PET etc) or within the lamination interlayer, in particular wire(s) of diameter less than 12 μm (so as to be invisible) or the tactile control zone as well as the power supply zone comprises an electroconducting layer which is:
on the face F4 (transparent especially if in the clear window region), with the tactile control zone or opposite the front face of the AMOLED screen or offset from the AMOLED screen optionally the electroconducting layer being absent opposite the front face of the OLED screen (for reasons of colors),
on the face F3, the electroconducting layer comprising an electrically insulated portion for the tactile control zone (transparent especially if in the clear window region), with the tactile control zone opposite the front face of the AMOLED screen or offset from the AMOLED screen, optionally the electroconducting layer is absent (via an opening) opposite the front face of the OLED screen (for reasons of colors),
on the face F2 with the tactile control zone offset from the AMOLED screen and the power supply zone optionally behind the AMOLED screen,
between the face F2 and the rear face of the AMOLED screen, with the tactile control zone offset from the AMOLED screen and the power supply zone optionally behind the AMOLED screen, notably on the face F2 the electro conducting layer preferably being on a flexible polymeric film of thickness less than 1 mm and even 0.5 mm notably protruding beyond the lip of the laminated glazing,
on the front face or spaced from the front face and between the front face of the AMOLED screen and the face F3 with the tactile control zone opposite or offset from the display zone.

The electroconducting layer can comprise a zone insulated electrically by at least one electric insulation track, and the electroconducting layer is chosen from among:
a solar control layer on the face F3 (substantially on the whole surface, covering at least 80%, and even at least 90% of the face F3), and/or a heating layer
a solar control layer on a flexible polymeric film between the face F2 and the face F3 (covering at least 80%, and even at least 90% of the face F3), notably laminated by the lamination interlayer.

The electroconducting layer can be an electroconducting enamel layer on the face F2 preferably on an, opaque, external masking layer made of enamel. It can be masked by an internal masking layer on face F3 or on face F4.

The electroconducting layer can be an electroconducting enamel layer on the face F3 preferably masked (from the exterior) by the, opaque, external masking layer made of enamel. It can also be masked by an internal masking layer on face F3 made of enamel (under this electroconducting enamel layer) or on face F4.

The glazing can comprise a plurality of AMOLED screens each with a dedicated tactile control zone or with a common tactile control zone or at least with a common switch.

The electroconducting structure can be a capacitive element. The capacitive element operates with a signal analysis and processing unit such as an electronic circuit or indeed a chip of qq mm² at most, also masked from the exterior. Any parasitic capacitance is avoided.

For example it comprises three electrodes used for so-called differential measurements or else with at least two electrodes, each electrode and linked to a conductor supplying them (of small dimensions with respect to the electrodes), conductors for example spaced apart by at most 1 mm. Conductor and electrode can be made of the same material for example with a metallic conducting film of sheet resistance of at most 10 ohms/square or indeed even of at most 5 ohms/square.

For example the capacitive element comprises two concentric electrodes, each comprising two sectors of annular general shape, linked respectively to conductors.

The electrodes and their conductors are also made in a cut conducting layer. The conductors are linked to a processing assembly. The conductors between the annular electrodes and the junction ends joining with the signal supply and processing device, are a distance d apart which is of the order of the dimension of the capacitive element. The mode of operation is that described previously. The frequency of analysis of the charge of the electrodes is fixed at 33 Hz . To further improve the “signal/ noise” ratio a peripheral strip of the conducting layer is earthed.

The conducting elements forming the capacitive element and the optional support are for example inserted into the glazing in a zone without internal and/or external masking. They are then of essentially transparent materials so as not to significantly interrupt the visual aspect of the glazing. In a preferred manner the support and the capacitive element, which is constructed in conducting layers applied to this support, are chosen so that they exhibit a luminous transmission determined according to the standard EN 410 which is not less than 70% and preferably not less than 80%.

The support used for the capacitive element is preferably of smallest possible thickness. If the support comprises only the capacitive element, a flexible film for example of polyethylene terephthalate termed PET, coated with the conducting layers can be used. In this case the thickness can be particularly small, of a few hundredths of a millimeter. The insertion of a support is done in a favored manner from an edge of the glazing.

All the constituents included in the cambered glazings must be able to withstand these curvatures, hence the necessity to use sufficiently flexible supports. Moreover when a support exhibits a non-negligible thickness of for example at least 0.15 mm and even of at least 0.2 mm, it is preferable, in order to facilitate assembly, to dispose these supports in a corresponding reserve made in a lamination interlayer sheet of like thickness.

The transparent electrical conducting products which can be used according to the invention to constitute the capacitive element comprise one or more sufficiently thin layers of conducting oxides, or of metallic layers the latter disposed in sets of dielectric protective layers.

Featuring among the most conducting oxide layers (TCO) are, in particular, layers based on indium oxide doped with tin oxide (ITO). These layers, at thicknesses meeting the transparency condition, make it possible to attain resistances of less than 50 Ω/α and preferably of less than 30 Ω/α and particularly less than 20 Ω/α. The electrical resistance of the layers is necessarily dependent on their thickness. An increase in the thickness makes it possible to reduce the resistance but has to cope with the necessity to preserve good transparency. For the layers of ITO type an acceptable absorption level corresponds to layers whose thickness does not exceed 300 nm, and preferably 200 nm.

The electrically conducting structure can contain at least one electrically conducting linear element. The electrically conducting linear element is preferably an electrically conducting wire. The wire is advantageously implemented very thin. The preferred wires have a thickness of less than or equal to 0.25 mm, in a particularly preferred manner of 0.02 mm to 0.15 mm. The wires are preferably metallic, in particular contain copper, tungsten, gold, silver or aluminum or alloys of at least two of these metals or are made of this. The alloys can also contain molybdenum, rhenium, osmium, iridium, palladium or platinum.

The wire is preferably electrically insulated, for example, by plastic electrical insulation cladding. This is particularly advantageous if the wire passes over an electrically conducting layer or other electrically conducting voltage-carrying elements and/or touch-keys of the glazing.

In another advantageous embodiment, the electrically conducting structure contains at least one printed thin structure consisting of a conducting material, for example, a printing paste drawn with metallic particles. The electrically conducting structure can be produced by printing and firing of a conducting paste. The conducting paste preferably contains silver particles and glass frits. The layer thickness of the fired paste is preferably from 5 μm to 40 μm, in a particularly preferred manner from 8 μm to 20 μm. The drawn silver adhesively stick itself has light-scattering properties and can, consequently, itself serve signifies a deviation of the light.

In another advantageous embodiment, the electrically conducting structure comprises an electroconducting transparent layer. This is particularly advantageous since, then, the electrically conducting structure hardly, if at all, affects vision through the glazing.

In a particularly advantageous embodiment of a glazing according to the invention, the electrically conducting structure of the switching surface and a heating zone are parts of the same electroconducting layer and are separated electrically from the electroconducting transparent layer by at least one separation line. The width of the separation lines is preferably from 30 μm to 200 μm and in particular preferably from 70 μm to 140 μm. These thin separation lines allow secure and sufficiently high electrical insulation, and, at the same time, hardly, if at all, disturb vision through the glazing. The production of the separation lines is preferably performed by laser structuring or chemical or mechanical removal. Such an arrangement of switching surface and of a heating zone made on the basis of the same layer is particularly simple and economical to produce.

The tactile control zone preferably has an area of from 1 cm² to 200 cm², more preferentially from 1 cm² to 10 cm². The surface of the switch can, for example, have the shape of an oval, an ellipse or a circle, a triangle, a rectangle, a square or another type of quadrilateral or a higher polygon, in particular, circular, elliptical or drop-shaped shapes or shapes with rounded corners as well as strip shapes.

The surface can be connected electrically to an electronic assembly, in particular galvanic, capacitive and/or inductive.

In an advantageous embodiment, a heating zone comprises a plurality of individual metallic wires, termed “heating wires”, between bus bars case. The wires are advantageously implemented very thin, notably a thickness of less than or equal to 0.1 mm, in a particularly preferred manner of 0.02 mm to 0.04 mm, and in particular of 0.024 mm to 0.029 mm. The metallic wires preferably contain copper, tungsten, gold, silver or aluminum or alloys of at least two of these metals. The alloys can also contain molybdenum, rhenium, osmium, iridium, palladium or platinum.

The tactile (switching) control zone is defined by the shape and the size of the surface electrode. The capacitance of a surface electrode is measured by an external electronic assembly. The capacitance of the surface electrode changes with respect to the ground when the earth is a member in its proximity or, for example, in contact with an insulating layer on the surface electrode. The insulation layer comprises, in particular, the substrate itself or an intermediate layer or a plate. The variation of the capacitance is measured by the detection electronics as a whole, and when a threshold value is exceeded, a switching signal is triggered. In a variant, the switching surface exhibits two electrically conducting structures.

In the case of an electrically conducting structure consisting of an electroconducting layer, this layer is advantageously divided by one or a plurality of other demarcation lines. It is particularly advantageous that the second electrically conducting structure borders the first electrically conducting structure at least partially and preferably completely. This bordering is advantageous since the influence of a heating zone and, in particular, a change of voltage in the heating zone on the switching surface is thus reduced.

In another advantageous embodiment according to the invention, the zone which surrounds has the same shape or a similar shape to the switching zone in particular, circular, elliptical, or shapes or shapes with rounded corners as well as strip shapes.

It is particularly advantageous that the second electrically conducting structure has another hookup zone which can be linked to the electronics. In such an arrangement, the first and the second electrically conducting structure forming two electrodes which are capacitively coupled to the other. The capacitance of the capacitor formed by the electrodes varies with the proximity of a body, for example, a part of a human body. The variation of the capacitance is measured by electronics and when a threshold value is exceeded, a switching signal is triggered. The sensitive zone is defined by the shape and the size of the zone in which the electrodes are capacitively coupled.

Alternatively, the surface of the switch can also have an inductive, thermal function or other functions which are contactless. “Contactless” signifies that, in order to trigger a switching operation, it is not necessary to touch the electrically conducting structure directly.

In an advantageous embodiment of the glazing according to the invention, the electrically conducting structure, which forms the switching surface, can have three zones of different functionalities: the tactile control zone, a connection or hookup zone, which has an electrical line connection, to which the structure electrical conductor is linked electrically to the outside, and a supply zone, which links the tactile zone to the connection zone. The tactile zone is preferably larger than the supply zone. For example, the supply zone can have a small width and a large length; whilst, on the other hand, the tactile zone is preferably square, round, circular or drop-shaped and thus has a large touchable surface, for example, for one or a plurality of a person's fingers or of a surface of the hand.

The (transparent) AMOLED screen is furthermore in the clear window region or is masked by an, opaque, so-called external peripheral masking layer between the face F2 and the rear face of the AMOLED screen (preferably on face F2 and an enamel layer) and the connecting part is also optionally masked by the external masking layer (even when the AMOLED screen is in the clear window region).

The invention applies equally well when:
the AMOLED screen is in the clear window region and the connecting part is peripheral (notably opaque or slightly transparent) or absent (the connection element absent from the laminate, possibly being “wireless”)
the AMOLED screen and the connecting part are peripheral (notably opaque or slightly transparent).

The first tactile control zone can comprise (functionally):
a first power supply switch for turning the AMOLED screen both on and off, notably a capacitive system, notably part-insulated from the electroconducting solar control layer and/or heating layer by means of one or more insulating lines (cut trench-like, by laser ablation etc) that are as discreet as possible
a first navigation element of the AMOLED screen—optionally with a local marker such as an arrow for example oriented downwards—for going (descending) from one line or zone to another line or other zone of a (main or secondary) menu of the AMOLED screen.

Intuitively (or with the aid of an onboard manual), the driver or copilot can touch the switch or the navigation element.

Preferably the first control zone is accessible without the driver leaning toward the windshield or at least rising slightly from their seat, notably with an arm still bent.

As other navigation element it is possible to have:
an element for setting the AMOLED screen to telephone mode (for example for selecting the recorded contacts)
an element for viewing a route on the AMOLED screen.

The first tactile control zone can comprise (functionally):
a first power supply switch (optionally with a local marker: symbol etc) for turning the

AMOLED screen both on and off, notably a capacitive system, notably part-insulated from the electroconducting solar control layer and/or heating layer by means of one or more insulating lines (cut trench-like, by laser ablation etc) that are as discreet as possible
a first navigation element of the AMOLED screen preferably with a first local marker such as an arrow for example oriented downwards for descending (from one zone) to another line (zone) of a (main or secondary) menu, of the AMOLED screen
a second navigation element of the AMOLED screen preferably with a second local marker such as an arrow for example oriented upwards for ascending from one line (of a zone) to another line (zone) of a (main or secondary) menu of the AMOLED screen 3.
a third navigation element of the AMOLED screen preferably with a third local marker such as an arrow for example oriented toward the left for going from one line (of a zone) to another line (zone) of a (main or secondary) menu of the AMOLED screen,
a fourth navigation element of the AMOLED screen preferably with a fourth local marker such as an arrow for example oriented toward the left for going from one line (of a zone) to another line (zone) of a (main or secondary) menu of the AMOLED screen,
a fifth navigation element of the AMOLED screen preferably with a fifth local marker for changing the function of the AMOLED screen (telephone mode, alert mode etc).

A navigation element or a switch (or “button”) according to the invention can therefore have a local marker. A local marker can be a white or black enamel on the face F3 or F4 (outside restricted zone B preferably). The marker can also be a sticker on the face F4. A local marker can be luminous and can even also consist of the AMOLED screen itself in particular when the AMOLED screen is in the clear window region and when the LT in this zone is at least 70% (restricted zone B). The screen can indicate the location or locations that can be selected and at the same time display the respective function at the level of the button itself. The display can be symbolic with pictograms or by writing. Like this, it is possible with very few buttons to create a relatively user-friendly piloting system where the buttons change function according to the situation.

Once the AMOLED screen is on, the ‘on’ button (switch) can for example become a button for validation (navigation element). Two additional buttons can serve to navigate inside a menu which opens once the AMOLED screen is on. A button can turn itself off when the function is no longer accessible, for example after having come to the end of the functions available in the menu.

It is also possible to use a temporal function to manage the buttons (navigation elements, even switch). For example turn off the menu if there has been no validation after a certain time. Provision may also be made to turn off the AMOLED screen by pressing the validation button for a longer time or else to activate a particular function by pressing two touch-keys at once for a certain time.

It is very possible to pilot an AMOLED screen with only three buttons.

The menu need not necessarily be displayed under the buttons, but can appear on the whole or on a part of the AMOLED screen to thus give a better overall view. Two additional buttons make it possible to manage a still more complex menu with for example four arrows as on a standard keyboard.

A positioning of the buttons below or to the side of the AMOLED screen possesses other advantages. This makes it possible to avoid the use of a conducting layer segmented at the level of the AMOLED screen and to see fingermarks on the AMOLED screen.

The tactile control zone can be connected preferably firmly to an edge of the AMOLED screen. It is then in the same plane and preferably with means of substantially the same thickness as the AMOLED screen.

The AMOLED screen (like the optional connection element) is preferably within lamination for better mechanical resilience. Thus, the lamination interlayer is then present at the front and at the rear of the AMOLED screen (like the optional connection element) this being advantageous with respect to a dissymmetric solution in which the AMOLED screen (like the optional connection element) is added (against or fixed by double-sided adhesive or glue or contact by adhesion) to the face F2 or the face F3.

For road vehicle windshields in particular, the glazings are preferably cambered and even in two directions, and preferably with two mineral glass glazings and even with a PVB lamination interlayer. In this case, the flexible AMOLED screen adapts to the curvatures like the optional connecting part (on flexible film).

Preferably the laminated glazing forms a windshield of a road vehicle such as an automobile, a truck, with the first and second mineral glass glazings cambered and even a PVB lamination interlayer and an AMOLED screen within the lamination (just like the connecting part).

The AMOLED screen can be opaque or transparent. The transparent AMOLED screen (in the clear window region in a peripheral zone or otherwise) is preferably defined by a luminous transmission (LT) of the zone of the laminated glazing comprising it at least equal to 70%.

The less transparent AMOLED screen (intended always to be peripheral) is preferably defined by a luminous transmission (LT) of the zone of the laminated glazing comprising it of less than 20% or even than 10%.

An opaque AMOLED screen can be defined as having a zero LT (for example by addition of a layer or paint—metallic . . . —at the rear of the carrier substrate of the AMOLED system).

In one embodiment, the AMOLED screen is opaque or transparent with a luminous transmission LT of less than 10% and even less than 5% and/or the connecting part is opaque or of luminous transmission LT of less than 10% and even than 5%.

In the case of a windshield in particular (notably road vehicle), this AMOLED screen—preferably in configuration a)—can be arranged peripherally and preferably in the central zone of the upper longitudinal edge in particular in a zone where the width of the external masking layer is of larger width L1 than its width LO on the drivers and/or copilot's side.

This makes it possible to arrange an AMOLED screen (opaque or slightly transparent) of larger size notably with a larger height H3 (dimension along the vertical). The AMOLED screen can also be more toward the center (edge as close as possible to the boundary).

Preferably, the external masking layer is made of enamel and on face F2 behind the AMOLED screen and the optional other AMOLED screen or screens.

In the off state, the AMOLED screen zone might not be distinguishable from the masking zone further to the rear. Provision may be made to adapt the color of the external masking layer (enamel notably, on face F2) accordingly.

In one embodiment, the AMOLED screen is transparent and in the clear window region or in that the (transparent or opaque) AMOLED screen is masked by a so-called external masking layer between the rear face of the AMOLED screen and the face F2 (and/or the electrical connection element is masked from the exterior notably by a so-called external masking layer between the rear surface and the face F2 and the technical edge or edges of the AMOLED screen as well as the connection element are masked from the interior by a so-called internal masking layer on face F3 or F4.

In a preferred embodiment, the AMOLED screen covers at most the entire peripheral zone visible by the driver (or copilot if AMOLED screen on the latter's side) in the (automotive) road vehicle windshield up to the edge of the transparent central vision zone and more precisely:
up to the upper edge of the transparent central vision zone if the AMOLED screen is arranged at the top in a horizontal manner on the drivers side (or copilot's side if AMOLED screen on the latter's side) along the drivers (or passengers) side upper longitudinal edge
up to the lower edge of the transparent central vision zone if the AMOLED screen is arranged at the bottom in a horizontal manner on the drivers side (or copilot's side if AMOLED screen on the latter's side) along the driver's (or passenger's) side lower longitudinal edge
up to the upper edge of the transparent central vision zone if the AMOLED screen is arranged at the top in a horizontal or vertical manner in the central zone of the upper longitudinal edge
up to the left edge of the transparent central vision zone (respectively right) if the AMOLED screen is arranged in a vertical manner on the left preferably drivers side (respectively right preferably copilot's side) along the left lateral edge, preferably in the bottom part (lower half of the lateral edge) so as to be wider.

The same holds for said other AMOLED screen or screens—if opaque or slightly transparent preferably masked by the external masking layer, preferably on face F2—.

The upper, lower, lateral (left and right) edges (or limits) of the transparent central vision zone are notably defined by a regulating standard. For example for an automotive road vehicle windshield, this involves the restricted zone B defined according to European standard UN-ECE R43 annex 18, in particular page 133 and § 2.4.The upper limit of the transparent central vision zone is preferably defined on the basis of an angle between the horizontal and 7° from a reference point (the drivers eye, eye at the height Z with respect to the seat of the vehicle with Z=665 mm for a tall driver or Z=589 mm for a short driver.

From the edge concerned of the laminated glazing notably road vehicle windshield, the following distances are defined:
h1 distance between the upper edge and the upper limit of the peripheral zone of vision of the driver (or of the copilot if AMOLED screen on the latter's side) in the vehicle, preferably of at least 15 mm and even of at least 50 or 90 mm
h′1 distance between the lower edge and the lower limit of the peripheral zone of vision of the driver (or of the copilot if AMOLED screen on the latter's side) in the vehicle preferably of at least 40 mm and even of at least 100 or 200 mm
h4 distance between the lateral (left or right) edge and the lateral limit of the peripheral zone of vision of the driver (or of the copilot if AMOLED screen on the latter's side) in the vehicle preferably of at least 15 mm and even of at least 20 or 40 mm.

Away from the zone of the AMOLED screen (and/or of said other AMOLED screens) it is possible to form an external peripheral masking layer (on face F2) like enamel, from the lip up to h1, h′1, h4 while protruding beyond for example the (predetermined) vision zone by at most 2 cm as conventionally.

According to the invention, it is possible to increase in a way the width of the external masking layer so as to mask the AMOLED screen (and said other AMOLED screen or screens) and at the maximum up to the limits of the central transparency zone. The external masking is therefore possible from the limit of the restricted vision zone B up to the edge of the (first) glazing.

As a function of the edge concerned of the laminated glazing notably road vehicle windshield, the following distances are defined:
h2 distance between the upper edge and the upper limit of the central zone of transparency on the driver's side (or copilot's side if AMOLED screen on the latter's side), preferably of at least 120 mm and even of more than 150 mm or 200 mm or 220 mm,
h′2 distance between the lower edge and the lower limit of the central transparency zone on the drivers side (or copilot's side if AMOLED screen on the latter's side) preferably of at least 120 mm and even of more than 150 mm or 300 mm,
Hₐ distance between the upper edge and the upper limit of the central transparency zone in the central part (for AMOLED screen in central position), preferably of at least 180 mm and even of at least 250 mm or 300 mm,
h5 distance between the lateral (left or right) edge and the lateral limit of the central zone of transparency on the drivers side (or copilot's side if AMOLED screen on the latter's side) preferably of at least 80 mm and even of more than 120 or 150 mm.

The height h6 of the restricted zone B in the top position (between the potentially opaque zone and the most central zone A) can be from 60 mm to 90 mm. It can serve for a (fairly) transparent AMOLED screen (which may ascend into the potentially opaque zone). Preferably the external masking layer is higher than the AMOLED screen.

The height h′6 of the restricted zone B in the bottom position (between the potentially opaque zone and the central-most zone A) can be between 60 mm and 90 mm. It can serve for a (fairly) transparent AMOLED screen (which may descend into the potentially opaque zone). Preferably the external masking layer is lower than the AMOLED screen.

The external masking layer zone is preferably at least as large as the surface of the AMOLED screen, preferably slightly larger:
for example by at least 5 mm on each side of the AMOLED screen
and/or for example by at least 5 mm under the most central edge (bottom edge if position at the top of the AMOLED screen, bottom edge if position at the bottom of the AMOLED screen).

The external masking layer can be a solid zone (flat patch) extended by a discontinuous zone in the form of a network of patterns (geometric patterns, round, square, rectangular shape etc) preferably in gradation in the direction of the center of the laminated glazing (windshield). The gradation can be at most 15 mm and even at most 10 mm and at least 3 or 5 mm in width. The gradation can be in the zone of the lower longitudinal edge of at most 30 mm and even of at most 25 mm and of at least 10 or 15 mm in width. Preferably the AMOLED screen is not behind the gradation but behind the solid zone. At the limit only the gradation can protrude beyond the AMOLED screen.

It is possible with several masking zones widened along a reference edge or distinct edges and even a widened masking zone therefore dedicated for each AMOLED screen.

The laminated glazing notably an (automotive) road vehicle windshield of rectangular shape can be:
of width (horizontal dimension) Lp of at least 1200 mm and of at most 1850 mm and preferably from 1350 to 1550 mm.
of height (vertical dimension) Hp of at least 800 mm and of at most 1400 mm and preferably from 950 to 1050 mm.

Preferably the AMOLED screen (in an automotive road vehicle windshield) is at least 80 mm by 120 mm.

Preferably the height H3 (and W3) of the AMOLED screen in an automotive road vehicle windshield is adjusted as a function of the standard in force.

Preferably the width W3 of the AMOLED screen in an automotive road vehicle windshield arranged horizontally in the top position (upper edge) is at least 100 mm and better at least 120 mm and even greater than 200 mm, than 350 mm, and even greater than or equal to 500 mm, notably or over the entire drivers side zone between a first visible lateral edge and the top central zone (and even all or part of the top central zone included) or the entire copilot's side zone between the second visible lateral edge and the top central zone (and even all or part of the top central zone included).

Preferably the height H3 of the AMOLED screen in an automotive road vehicle windshield arranged horizontally in the top position (upper edge) is at least 80 mm and better at least 100 mm.

Preferably the width W3 of the AMOLED screen in an automotive road vehicle windshield arranged horizontally in the bottom position (lower edge) is at least 100 mm and better at least 120 mm and even greater than 200 mm, than 350 mm and even greater than or equal to 500 mm, notably or over the entire drivers side zone between the visible lateral edge and a middle zone (and even all or part of the bottom central zone included) or the entire copilot's side zone between the second visible lateral edge and the bottom central zone (and even all or part of the bottom central zone included).

Preferably the height H3 of the AMOLED screen in an automotive road vehicle windshield arranged horizontally in the bottom position (lower edge) is at least 80 mm and better at least 100 mm.

Preferably the width W3 of the AMOLED screen in an automotive road vehicle windshield arranged vertically in the top position (upper edge) in the central zone is at least 100 mm and better from at least 120 mm to 280 mm or even 300 mm.

Preferably the height H3 of the AMOLED screen in an automotive road vehicle windshield arranged vertically in the top position (upper edge) in the central zone is at least 80 mm and better at least 100 mm and even from at least 150 mm and up to 200 mm.

The connection element can be “wireless”. A flexible (flat) connector according to the invention is however preferred for the transport of the power signals and/or data signals to one or more induction-based or capacitive etc. wireless connectors. The electrical connection element preferably of submicronic thickness E4 substantially equal to E2 and of thickness E′4 less than E4 beyond the lip of the second glazing, is preferably curved and against or better fixed by gluing on face F4 without stretching as far as the display zone. The exterior part, preferably of thickness E′4 less than E4, is preferably curved stretches along face F4 side and is against or better fixed by gluing on face F4 without stretching as far as the display zone.

The connection element is advantageously partially covered or shrouded, if appropriate, with any material so as to increase the thickness thereof to a value essentially equal to that of the AMOLED screen notably up to the edge of the laminated glazing.

The connection element is preferably a flexible printed circuit (“fpc”). The connection element is preferably capable of addressing a large number of pixels.

The width of the flexible electrical connection element (notably the connecting part) can be less than or substantially equal to that of the AMOLED screen, typically 50 mm in width for AMOLED widths (horizontal dimension) of at least 100 mm and even more than 150 mm. Large (wide) screens can have several flexible electrical connection elements preferably on one and the same edge of the AMOLED screen.

The distance between the termination of the electrical connection element and the lip of the second glazing is sufficiently large for this termination to be accessible during mounting or dismantling. The total length (unfolded) is adjusted for the connection element to be folded around the second glazing and fixed on face F4. From the exit of the interior glass, a distance of 20 to 150 mm is preferably envisaged.

In one embodiment, the electrical connection element (notably the connecting part) comprises:
a flexible support preferably polymeric, transparent or otherwise (such as a PET etc) with first front face and first rear face, wires or preferably conducting tracks on the front or rear side,
optionally electronic components such as transistors,
the wires or tracks (and electronic components) being covered by an electrically insulating substance, such as a layer of resin or varnish (liquid deposition etc) or a transparent or non-transparent protective film (PET, polyimide etc) for example adhesive-coated.

The connecting part can be linked by any known means to the AMOLED screen: clipping, plug-in. Preferably the connecting part and the AMOLED screen are linked by one or more permanent (solid) links. A link between the connecting part and the AMOLED screen can be made on a technical edge of the AMOLED screen.

Preferably, a polyethylene terephthalate PET, a polyimide, a polyester, a poly(vinyl chloride) PVC, a polycarbonate, polyetheretherketone (PEEK), an acrylate, is chosen as flexible polymeric film, doing so for one at least of the following elements:
the AMOLED screen (substrate, rear or front protective film: facade film etc),
the electrical connection element notably the connecting part (substrate, rear or front protective film).

The second glazing preferably comprises a local notch. The connection element exits the lip of the second glazing via the notch of width preferably at least the width of the connection element and preferably at most the width of the AMOLED screen (not including the radii of the fitting).

The dimensions of the notch are therefore adapted:
width of the notch greater than or equal to that of the connection element;
depth of the notch greater than or equal to the thickness of the connection element so as to avoid it being visible from the outside in a case when the edge is evident.

In practice the depth of the notch is preferably from 1.5 mm to 3 or even to 2 mm.

The notch zone is preferably (substantially) devoid of lamination interlayer.

The lamination interlayer of polymeric substance is chosen from among polyvinylbutyral, ethylene—vinyl acetate, ionomer polyurethane or resin, alone or in mixtures of several varieties of one of them and/or of several of them; the term “varieties” refers here to variations of the amount of plasticizer, of branchings/linearity, average molecular weight of the molecules.

To ensure good water-tightness, it surrounds and is in contact with the AMOLED screen (rim and front and rear face) indeed even of the electrical connection element of flat connector type.

The lamination interlayer can itself be made of polyvinylbutyral (PVB), polyurethane (PU), ethylene/vinyl acetate copolymer (EVA), formed from one or more films, having for example a thickness of between 0.2 mm and 1.1 mm.

The surface of the lamination interlayer can be smaller than the surface of the laminated glazing, for example leaving a groove (frame-like or banner-like), which is free and therefore unlaminated.

The first glazing like the second glazing may be parallelepipedal, with rectangular, square main faces or sheets or even of any other shape (round, oval, polygonal). The first and/or second glazing can (according to the esthetic result, the desired optical effect) be a clear glass (of luminous transmission LT greater than or equal to 90% for a thickness of 4 mm), for example a soda-lime standard composition glass such as Planilux® from the company Saint-Gobain Glass, or extra-clear glass (LT greater than or equal to 91.5% for a thickness of 4 mm), for example a soda-lime-silica glass with less than 0.05% of Fe III or of Fe₂O₃ such as Diamant® glass from Saint-Gobain Glass, or Optiwhite® glass from Pilkington, or B270® from Schott, or another composition described in document W004/025334.

The glass of the first and/or second glazing can be neutral (no coloration), or (slightly) tinted notably gray or green, such as the TSA glass from the company Saint-Gobain Glass. The glass of the first and/or second glazing can have undergone a chemical or thermal treatment of the hardening, annealing type or a tempering (for better mechanical strength notably) or be semi-tempered.

The luminous transmission LT can be measured according to ISO standard 9050:2003 using the illuminant D65, and is the total transmission (notably integrated in the visible region and weighted by the sensitivity curve of the human eye), taking account both of direct transmission and of possible diffuse transmission, the measurement being made for example with the aid of a spectrophotometer furnished with an integrating sphere, the measurement at a given thickness thereafter being converted if appropriate to the reference thickness of 4 mm according to ISO standard 9050:2003.

For a laminated vehicle glazing notably windshield or lateral glazing, the LT can preferably be at least 70% and even at least 75% or 80%.

In one embodiment the first glazing is made of mineral glass and the second glazing is made of organic glass (such as PC, PMMA, cyclo-olefin copolymer (COC) or else polyethylene terephthalate (PET) optionally protected by a coating (on face F4).

The exterior glazing can comprise functional thin layers on one or the other of its faces F1 and F2 or else both: it is possible to cite a photocatalytic self-cleaning or hydrophobic layer on face F1.

Preferably the laminated glazing forms a windshield of a road vehicle such as an automobile, a truck, with the first and second glazing cambered and even a PVB lamination interlayer. The camber of the first and second glazings (windshield) can be in one or more directions for example as described in document W02010136702.

The AMOLED screen can preferably have a thickness of at most 0.8 mm, preferably at most equal to 0.7 mm, and in a particularly preferred manner at most equal to 0.6 mm and even of at least 0.15 mm.

The AMOLED screen preferably comprises a flexible support (polymeric, glass or indeed a metal) bearing a so-called lower electrode (often the anode) of an organic light-emitting system and an upper electrode, while including a matrix of thin-film transistors (‘TFT’). Other functional elements or layers are possible notably:
between the support and the lower electrode and in the form of a deposition or film: barrier layer (against oxygen, moisture etc),
on the upper electrode and in the form of a deposition or film: protective layer (against oxygen, moisture etc), for example a deposition (varnish, shrouding, resin etc) and/or facade film (transparent polymeric film: PET etc).

More precisely the pixel preferably comprises side by side two or three of the following systems:
an organic light-emitting system emitting in the red termed “R”,
an organic light-emitting system emitting in the green termed “G”,
an organic light-emitting system emitting in the blue termed “B”,
an organic light-emitting system emitting in the white termed “W”; in particular RGB, RWB, WBG, RWB, W, BG.

The number of pixels is at least 64×128. The emission is of top emitting type (emission away from the substrate). Front face is intended to mean the viewing face.

Provision may be made for means for modulating the power of the AMOLED screen according to at least two configurations: a configuration for nighttime vision, in which the power of the AMOLED screen is adjusted so that the luminance typically lies between about 10 and about 400 Cd/m² and a configuration for daytime vision, in which the power of the AMOLED screen is adjusted so that the luminance typically lies between about 10 and about 500 Cd/m². In daytime vision, it is also possible to adjust the luminance of the AMOLED screen as a function of the exterior illumination.

All information can be displayed on the AMOLED screen (notably on a windshield): exterior and interior atmospheric conditions, vision of the rear environment, vision of the left and right lateral environment (as already indicated), information related to the driving conditions and signposts, technical information relating to the transport vehicle.

The AMOLED screen in particular can have one or more of the following functions (which can be aggregated):
central vison of the rear,
display of driving aid information, in particular alerts, detection of obstacles,
display of information (levels, operating state, state of wear, etc) on the characteristics of the vehicle (engine, wheels, brakes, headlights etc), in particular in case of alert (with a requested stop),
display of information on the exterior environment: weather, distance to a service station (to an electricity point etc), to a town, to a highway exit,
display of information on connectivity: access to the network (social network, Internet etc),
operation in telephone mode: display of the speaker, of a person (police, medical setting) in case of emergency and/or of accident or of a risk situation.

The AMOLED screen and/or another AMOLED screen can also act as copilot side TV, or as operation in telephone mode: display of the speaker, of a person (police, medical setting) in case of emergency and/or of accident or of a risk situation.

The AMOLED screen can display several images as in a television
main image (central vision of the rear etc)
inlaid image(s) (lateral vision of the vehicle etc).

The AMOLED screen is notably rectangular or square.

On the front face side, at least one peripheral band termed the technical edge of the AMOLED screen (distinct zone from the active zone, for display) can be masked by a so-called internal masking layer, preferably of enamel, on the face F3 or F4 or by a masking element (opaque layer, film) on the front face. And/or the front surface of the connection element (the connecting part) can be masked by a (same) so-called internal masking layer, preferably of enamel, on the face F3 or F4 or by a masking element (opaque film) on the front surface.

The internal masking layer is optionally a flat patch with an opening revealing the display zone and of width less than or equal to the width of the external masking layer.

The internal masking layer can form not only:
a masking of the connecting part, opaque or slightly transparent,
as well as a masking of the technical edges of the AMOLED screen, seen from the interior side of the glazing, notably of the windshield,
and even, by protruding beyond the technical edge or edges, of the junction between the lamination interlayer and the AMOLED screen, which junction may comprise irregularities and flaws, (and even of the junction between the lamination interlayer and the connecting part).

The masking element can form part of a support film and/or protection such as polyethylene terephthalate (PET) of the AMOLED screen and of the connecting part.

The opaque film can be stuck to the whole of the AMOLED screen and of the connecting part immediately when premounted with a view to its storage, or else form part of a film which has been stuck to this premounted assembly, from which film can then optionally be removed an undesired part precut before assembling the windshield.

The masking element (opaque film etc) can form not only:
a masking of the connecting part, opaque or slightly transparent,
as well as a masking of the technical edges of the AMOLED screen, seen from the interior side of the windshield,
and even, by protruding beyond the technical edge or edges, of the junction between the lamination interlayer and the AMOLED screen, which junction may comprise irregularities and flaws, (and even of the junction between the lamination interlayer and the connecting part).

The opaque film can also be an opacified extension of the transparent polymer material covering the AMOLED screen, that is to say be an integral part thereof.

The opaque film can also alternatively or cumulatively be an extension of the polymer material covering the connecting part, that is to say be an integral part thereof.

The internal masking layer or the masking element (the opaque film) can protrude beyond the technical edges by at least 0.1 mm and even by at most 5 mm or 2 mm.

The two embodiments with internal masking layer/masking element are not necessarily mutually exclusive, and it is possible to contemplate a masking of the technical edge of the AMOLED screen according to the first embodiment and a masking of the connection element (the connecting part) according to the second, or a double masking of the technical edge of the AMOLED screen or of the connection element according to both embodiments at the same time.

The function of the masking is to hide non-useful and unsightly parts of the device so that only the useful part thereof remains visible from the interior; any method suited to the nature of the substrate according to the first or second embodiment can be employed: printing such as ink jet, silk-screen, enamel as on the face F2.

The internal masking layer can confine itself to masking the technical edge or edges and a part (at least the visible part) of the electrical connection element (of the connecting part), or even protrude optionally a little by at most 1 to 2 cm. The internal masking layer can be in the zone with the AMOLED screen of width less than or equal to that of the external masking so that the external masking is visible by transparency on either side of the AMOLED screen.

An internal and/or external masking layer can be a dark (black) enamel layer, but more broadly a layer of opaque paint or ink, or a painted polymer layer (e.g. printed PVB), for example polyethylene, polymethyl methacrylate (PMMA).

The external masking layer on face F2 and the internal one on F3 or F4 preferably consist of the same material and even enamel. It is preferred to have an enamel layer at least on face F2 and even on face F4.

In order to limit the warming in the cabin or to limit the use of air conditioning, one of the glazings at least (preferably at least the first glazing) is preferably tinted.

The laminated glazing can comprise a layer which reflects or absorbs solar radiation termed a solar control layer, preferably on face F3 or indeed on face F2 of the second glazing (preferably clear). This electroconducting layer is transparent since it is in part in the clear window region.

The solar control layer can also serve as heating layer with a current infeed at the periphery.

In particular, a heating zone which is connected to at least two electroconducting busbar bars intended for connection to a voltage source in such a way that a current path for a heating current is formed between them.

The width of the busbars is preferably from 2 mm to 30 mm, in a particularly preferred manner from 4 mm to 20 mm and in particular from 10 mm to 20 mm.

A printed busbar preferably contains at least one metal, a metallic alloy, a metallic and/or carbon compound, in particular preferably a noble metal and, in particular, silver. The printing paste preferably contains metallic particles, metallic and/or carbon particles and, in particular particles of noble metal such as silver particles. The thickness of a printed busbar can preferably be from 5 μm to 40 μm, in a particularly preferred manner from 8 μm to 20 μm and more particularly preferably from 8 μm to 12 μm.

As a variant, however, a busbar can also be in the form of a strip of an electrically conducting sheet. The busbar then contains, for example, at least aluminum, copper, tinplated copper, gold, silver, zinc, tungsten and/or tin or alloys of these. The strip preferably has a thickness of 1 μm to 500 μm, in a particularly preferred manner of 30 μm to 300 μm.

The solar control and/or heating layer can comprise a stack of thin layers comprising at least one metallic functional layer such as silver (on F2 or preferably F3). The or each functional layer (silver) is disposed between dielectric layers.

The functional layers preferably contain at least one metal, for example, silver, gold, copper, nickel and chromium, or a metallic alloy. The functional layers in particular preferably contain at least 90% by weight of metal, in particular at least 99.9% by weight of metal. The functional layers can be made of metal for the metallic alloy. The functional layers contain in a particularly preferred manner silver or an alloy containing silver. The thickness of a functional layer (silver etc) is preferably from 5 nm to 50 nm, more preferentially from 8 nm to 25 nm. A dielectric layer contains at least one individual layer made of a dielectric material, for example, containing a nitride such as silicon nitride or an oxide such as aluminum oxide. The dielectric layer can however also contain a plurality of individual layers, for example, individual layers of a dielectric material, layers, smoothing layers, which corresponds to blocking layers and/or antireflection layers. The thickness of a dielectric layer is, for example, from 10 nm to 200 nm. This layer structure is generally obtained through a succession of deposition operations which are performed by a vacuum method such as magnetic cathodic sputtering, supported on-site.

The electroconducting layer is a layer (monolayer or multilayer and therefore stack) preferably of a total thickness of less than or equal to 2 μm, in a particularly preferred manner less than or equal to 1 μm.

The electroconducting layer can have a resistance of 0.4 ohms/square to 10 ohms/square of sheet and even of 0.5 ohms/square to 1 ohm/square, typically with onboard voltages of 12 V to 48 V or, in the case of electric vehicles, with typical onboard voltages of up to 500 V.

It is possible to aggregate electroconducting layer (in silver etc) on face F2 and/or F3. The electroconducting layer on face F3 is for example a stack marketed by the Applicant Company under the name Climacoat. For example, it can be covered directly with a masking of one or more technical edges of the AMOLED screen (detailed previously) and/or of the connecting part.

Alternatively it is possible to use an electroconducting layer on a support, preferably flexible transparent polymeric (polyethylene terephthalate termed PET etc) between the face F2 and F3 (preferably laminated by the interlayer rather than glued) so as to be a solar control, optionally heating, layer (with at least two busbars notably as aforementioned).

Hence, in one embodiment, the glazing (preferably the, notably road, vehicle windshield) comprises between the face F2 and the face F4, notably on the face F3 or on the face F4, a preferably transparent electroconducting layer or a set of electroconducting wires (metallic preferably) that are preferably transparent or invisible. And optionally opposite the display zone, the electroconducting layer is absent (removed, by laser ablation or any other means etc) notably by means of an opening of size greater than or equal to the display zone or the set of electroconducting wires are absent (removed) notably by means of an opening (elimination) of size greater than or equal to the display zone.

The electroconducting wires are advantageously implemented very thin such that they are only slightly or not at all detrimental to transparency, notably a thickness of less than or equal to 0.1 mm, in a particularly preferred manner of 0.02 mm to 0.04 mm, and in particular of 0.024 mm to 0.029 mm. The metallic wires preferably contain copper, tungsten, gold, silver or aluminum or alloys of at least two of these metals. The alloys can also contain molybdenum, rhenium, osmium, iridium, palladium or platinum.

The electroconducting layer can cover at least 50% and even at least 70% or 80% or else at least 90% of the main face of the laminated glazing.

The electroconducting layer notably with said opening can be on the face F3 or on a flexible transparent polymeric film on the face F3 side (within the lamination interlayer preferably, closer to the face F3 than the AMOLED screen) and even be a solar control and/or heating layer which covers notably at least 50% and even at least 70% or 80% or else at least 90% of the face F3.

The opening (the absence of the electroconducting layer or electroconducting wires) makes it possible to remove the coloration due to the reflection of the electroconducting layer. It also increases the luminous transmission LT in this zone.

Preferably the second glazing clad with the electroconducting layer (with optional opening, for solar control and/or even heating) is a clear or extraclear glass, such as a Planiclear from the Applicant company (and the first glazing remains tinted).

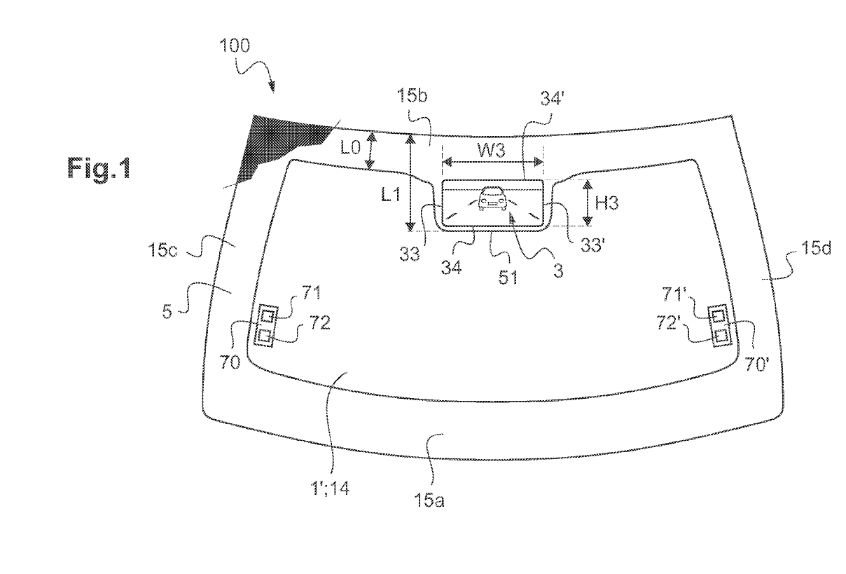

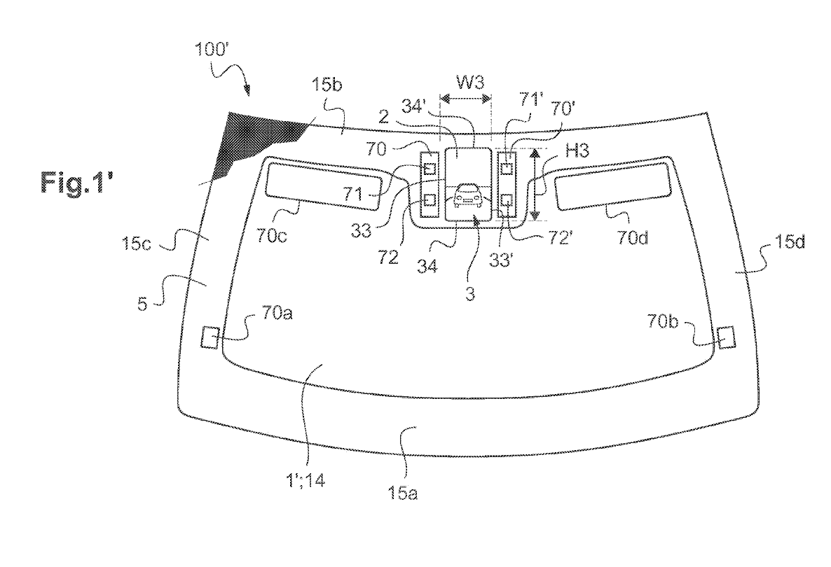

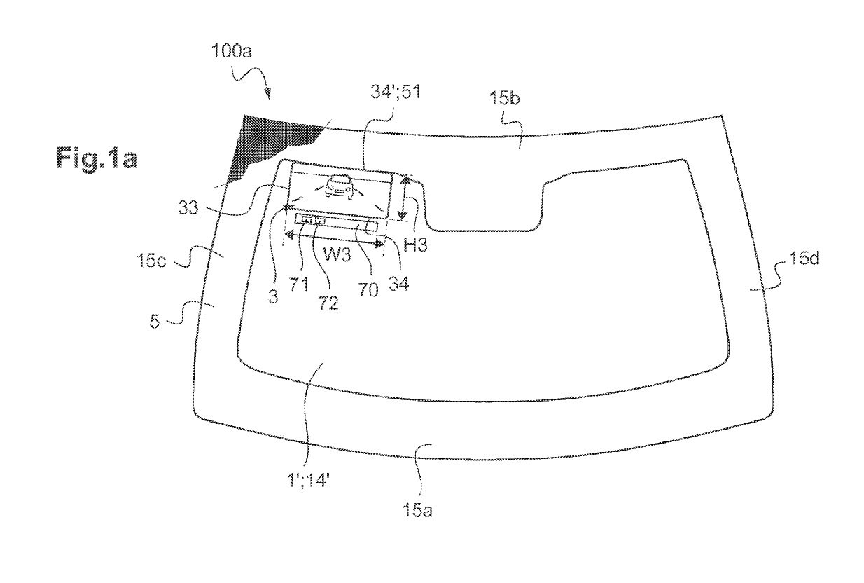

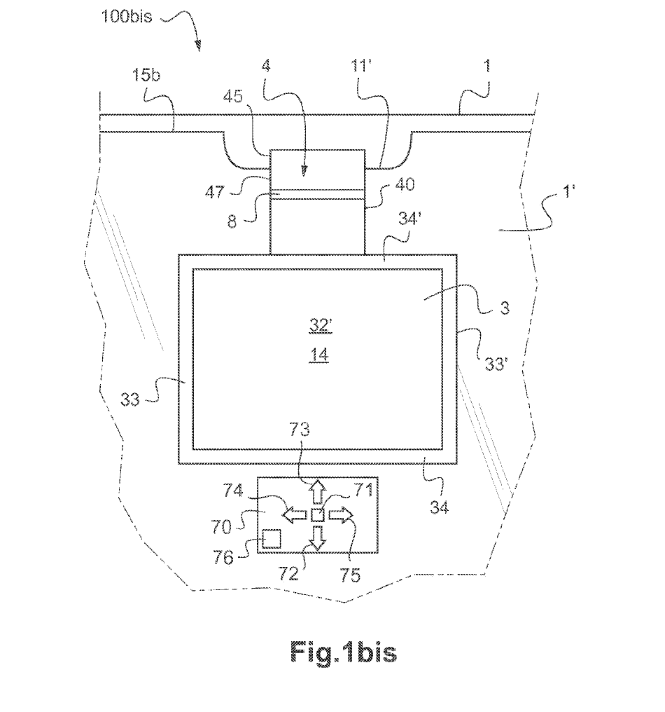

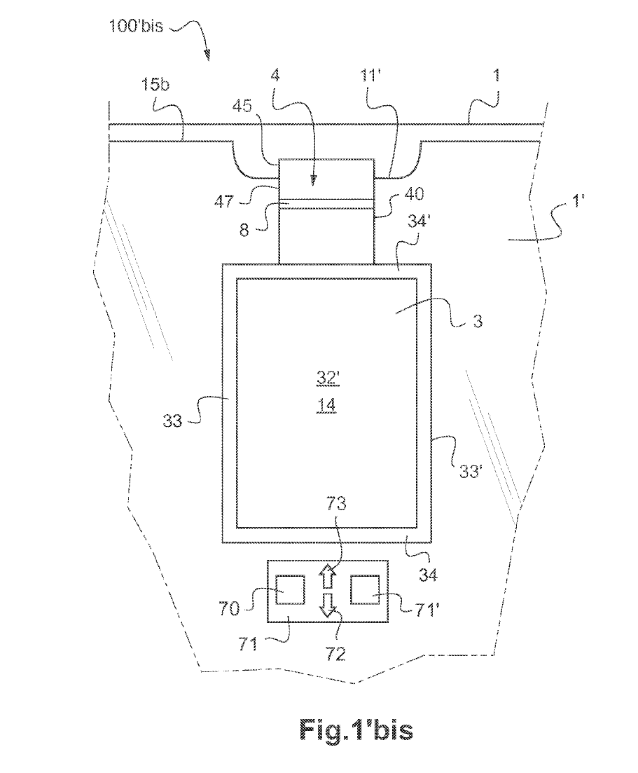

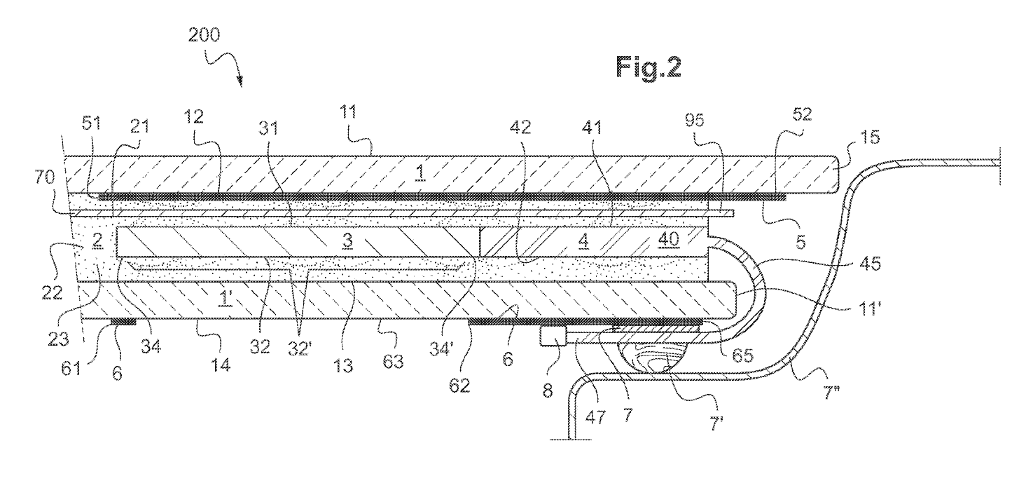

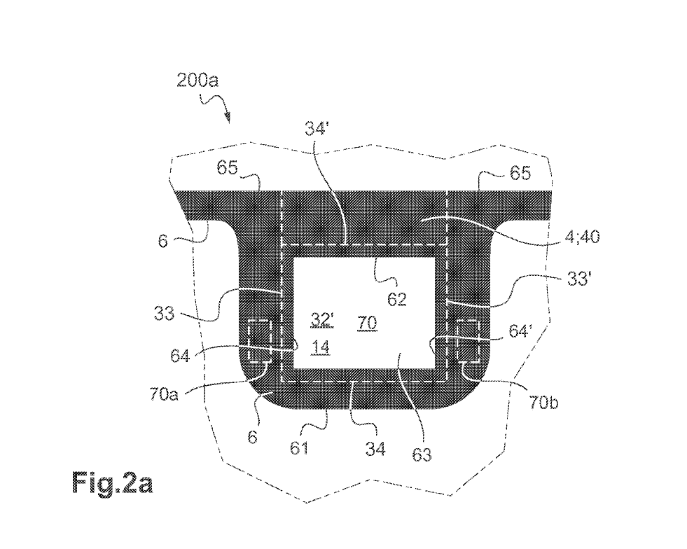

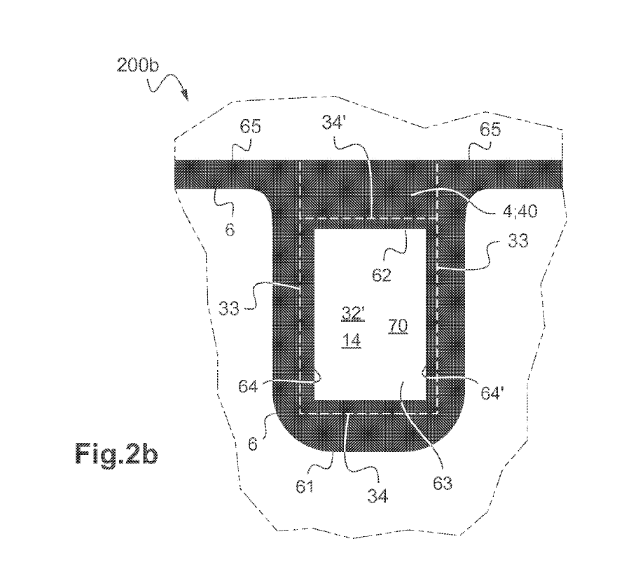

The present invention will be better understood and other details and advantageous characteristics of the invention will be apparent on reading the examples of laminated vehicle glazings according to the invention and illustrated by the following figures:
FIGS. 1, 1′, 1a, and 8 are each a face-on schematic view of a windshield with AMOLED screen of an automotive vehicle, inside view
FIGS. 1bis, 1′bis, 2a, 2b are face-on and detail schematic views of a windshield with AMOLED screen of an automotive vehicle, inside view
FIGS. 2, 3, 4, 5, 6, 7 are sectional and partial schematic views of a windshield with AMOLED screen of an automotive vehicle, inside view.

It is specified that out of concern for clarity the various elements of the objects represented are not necessarily reproduced to scale. For simplicity, the glazings are not represented cambered nor are the flexible elements in the lamination represented curved while adapting to this or these curvatures (in two dimensions) of glazing.

FIG. 1 is a partial schematic representation viewed from the interior of a windshield with AMOLED screen 100 of an automotive vehicle.

The windshield 100 comprises a clear view central zone (central part of the interior glazing 1′ therefore face F4 side 14) and an external masking peripheral frame 5, bottom 15a and top 15b, left lateral 15c and right lateral 15d longitudinal edges, frame here masking the rear of the opaque or slightly transparent AMOLED screen 3 (not transparent enough to be in the clear window region). The external masking layer 5, on face F2, thus hides from a view of the exterior of the vehicle the AMOLED screen 3 (and its connector not represented here, preferably in the laminate). The function of the enamel 5 is first to hide, viewed from the face F1, the glue bead fastening the final laminated glazing to the bodywork bay.

The AMOLED screen is arranged in a central position of the top longitudinal edge 15b in a horizontal manner and is rectangular. It is (all or part) in a so-called widened zone the width (vertical dimension) L1 of whose enamel is larger than the adjacent width L0 (for example on the left) serving for the conventional and even copilot side masking. For example, the horizontal dimension or width W3 is at least 120 mm and even up to 250 mm. The vertical dimension or height H3 is at least 75 mm.

Here the AMOLED screen 3 is down at the bottom-most of the widened peripheral zone. Its bottom edge 34 is in proximity to or on the boundary of the enamel flat patch 51 (solid zone) rather than on the boundary of the optional zone with enamel patterns for example at most 15 mm in width. Its top edge 34′ can be as high as possible (to the limit of the zone of vision in the cabin), typically at least 15 mm and better at least 70 mm. This depends on the design of the windshield (size, inclination, clear view desired by the maker).

The edges 53, 53′ of the widened enamel zone 50 can protrude beyond the lateral edges 33 and 33′ for example by at most 2 cm or even 1 or 0.5 cm (limit of the solid zone). In the off state, the AMOLED screen is dark and is even barely if at all distinguishable from the enamel background 5 (protruding over the sides). It is possible to adapt the enamel color accordingly. Preferably the enamel is opaque and dark.

The AMOLED screen is here in a distinct peripheral zone from the transparent central zone termed zone A Z_{A} (the most central and in two parts, quadrilateral-like) or of the restricted zone B Z_{b} (dashed).

On the lit AMOLED screen 3, it is possible to see the central vision of the rear of the vehicle and preferably the lateral visions of the vehicle.

The AMOLED screen can have the rear vision function in which case it can be turned on automatically with the engine or by the driver. It can also have other functions which are further modifiable while on the move such as: telephone mode, television mode, display of environmental data or data on the road (maps, GPS etc) or on the vehicle, simultaneous display on one or more screen zones (for example in the manner of a mobile telephone screen).

A first tactile control zone 70 of the AMOLED screen which is for example a vertical rectangular strip is provided for at the periphery of the left lateral edge 15c (drivers side) in a transparent zone. Invisible means of tactile control or optionally ones with a marker (luminous etc) which are detailed hereinafter are therefore favored.

The tactile control zone 70 comprises:
a transparent electroconducting layer (monolayer or multilayer) between the face F2 and the face F3 (on the face F2, on the face F3 or else on a transparent polymeric flexible support) for example covering at least 90% of the face F2 or F3 and serving as solar control layer and/or heating layer or else one or more sufficiently fine electroconducting wires between the face F2 and the face F3 (in the PVB)
or a locally transparent electroconducting layer on the face F4.

The first tactile control zone 70 comprises (functionally):
a first power supply switch 71 for turning the AMOLED screen 3 both on and off, notably a capacitive system, notably part-insulated from the electroconducting solar control layer and/or heating layer by means of one or more insulating lines (cut trench-like, by laser ablation etc) that are as discreet as possible
a first navigation element 72 of the AMOLED screen 3—optionally with a local marker such as an arrow for example oriented downwards—for going (descending) from one line or zone to another line or other zone of a (main or secondary) menu of the AMOLED screen 3.

The local marker can be a white or black enamel on the face F3 or F4 (if it is accepted by the standard). The marker can also be a sticker on the face F4.

Intuitively (or with the aid of an onboard manual), the driver or copilot can touch the switch or the navigation element.

Preferably the first control zone is accessible without the driver leaning toward the windshield or at least rising slightly from their seat, notably with an arm still bent.

In a similar manner, a second tactile control zone 70′ of the AMOLED screen which is for example a vertical rectangular strip is provided for at the periphery of the right lateral edge 15d (copilot's side) in a transparent zone (symmetrically with the first zone). Invisible means of tactile control are therefore favored.

The second tactile control zone 70′ comprises:
a transparent electroconducting layer (monolayer or multilayer) between the face F2 and the face F3 (on the face F2, on the face F3 or else on a transparent polymeric flexible support) for example covering at least 90% of the face F2 or F3 and serving as solar control layer and/or heating layer or else one or more sufficiently fine electroconducting wires between the face F2 and the face F3 (in the PVB)
or a locally transparent electroconducting layer on the face F4.

The second tactile control zone 70′ comprises (functionally):
a second power supply switch 71′ for turning the AMOLED screen both on and off, notably a capacitive system, notably part-insulated from the electroconducting solar control layer and/or heating layer by means of one or more insulating lines (cut trench-like, by laser ablation etc)
a second navigation element 72′ of the AMOLED screen 3—optionally with a local marker such as an arrow for example oriented downwards—for going (descending) from one line or zone to another line or other zone of a (main or secondary) menu of the AMOLED screen 3.

As other navigation element it is possible to have:
an element for setting the AMOLED screen to telephone mode (for example for selecting the recorded contacts)
an element for viewing a route on the AMOLED screen. In a variant, not shown, the AMOLED screen is on the driver's side top longitudinal edge. It is higher but can be wider than in the central zone and protrude into the central zone (away from projecting enamel zone).

As a variant, not shown, the AMOLED screen is on the driver's side bottom longitudinal edge in the vision zone. It can be wider than in the central zone.

As a variant, not shown, the AMOLED screen is on the drivers side bottom lateral edge and is arranged vertically as low down as possible in the vision zone.

FIG. 1′ is a partial schematic representation viewed from the interior of a windshield 100′ with AMOLED screen of an automotive vehicle.

The windshield 100′ differs from that in FIG. 1 in that the AMOLED screen is arranged in a vertical manner (H3 larger and W3 smaller). For example H3 is 150 mm to 300 mm and W3 is 60 m to 120 mm.

The first and second tactile control zones 70, 70′ are displaced so as to be on either side of the AMOLED screen 3 as horizontal rectangular strips. The first and second tactile control zones 70, 70′ are:
in front of the masking background 5 but not masked by an optional internal masking layer (enamel on face F3 or face F4)
or more lateral and in a transparent zone (without external or internal masking).

Cumulatively or alternatively, it is possible to have first and second tactile control zones 70, 70′ as vertical rectangular strips respectively in a peripheral zone of the left lateral edge 15c (drivers side) in a zone with the masking background 5 and in a peripheral zone of the right lateral edge 15d (copilot's side) in a zone with the masking background 5 (symmetrically with the first zone).

Up till now, the buttons have been fairly close together. Cumulatively or alternatively, it is possible to have first and second tactile control zones 70c, 70d as more stretched horizontal rectangular strips:
in a transparent zone (clear window region) on the left of the central zone and in a transparent zone (clear window region) on the right of the central zone, for example at least 20 cm or more in width (horizontal dimension),
or in a zone with the exterior masking background 5.

As a variant, not shown, two AMOLED screens are disposed in this central zone on either side of the AMOLED screen:
for example also arranged in a vertical manner
for example arranged in a horizontal manner

Each AMOLED screen has an individual tactile control zone or one which is common to the other AMOLED screens or at least shares the switch.

Preferably, use is made of a plurality of insulated zones of an electroconducting layer, notably transparent, (if necessary) between the face F2 and the face F3.

FIG. 1a is a partial schematic representation viewed from the interior of a windshield 100a with AMOLED screen of an automotive vehicle.

The windshield 100a differs from that in FIG. 1 in that the AMOLED screen is arranged in a transparent zone (required) for example with the top edge 34′ at the limit of the solid zone 51.

A first tactile control zone 70 of the AMOLED screen which is for example a horizontal rectangular strip is provided for at the periphery under the bottom edge 34 (drivers side) in the transparent zone. Invisible means of tactile control or optionally ones with a marker (luminous etc) which are detailed hereinafter are therefore favored.

The tactile control zone 70 comprises:
a transparent electroconducting layer (monolayer or multilayer) between the face F2 and the face F3 (on the face F2, on the face F3 or else on a transparent polymeric flexible support) for example covering at least 90% of the face F2 or F3 and serving as solar control layer and/or heating layer or else one or more sufficiently fine electroconducting wires between the face F2 and the face F3 (in the PVB)
or a locally transparent electroconducting layer on the face F4.

The first tactile control zone 70 comprises (functionally):
a first power supply switch 71 for turning the AMOLED screen 3 both on and off, notably a capacitive system, notably part-insulated from the electroconducting solar control layer and/or heating layer by means of one or more insulating lines (cut trench-like, by laser ablation etc) that are as discreet as possible
a first navigation element 72 of the AMOLED screen 3—optionally with a local marker such as an arrow for example oriented downwards—for going (descending) from one line or zone to another line or other zone of a (main or secondary) menu of the AMOLED screen 3.

FIG. 1bis is a face-on and detail schematic view of a windshield 100bis with AMOLED screen of an automotive vehicle, inside view showing another possible position of tactile control zone 70.

For simplicity the external masking layer is not represented although it covers the zone of the AMOLED screen (which is peripheral, opaque or slightly transparent). The solid-line elements are seen by transparency through the interior glazing 1′.

As in FIG. 1, the AMOLED screen 3 is arranged horizontally in the central zone of the top longitudinal edge 15b. The windshield 100bis comprises an exterior mineral glass sheet 1 and an interior mineral glass sheet 1′ whose upper edge 15b exhibits a notch 11′.

The OLED screen 3 is sandwiched between the exterior glass sheet 1 and the interior glass sheet 1′. It exhibits a display zone 32′ flanked by one or more technical edges (here four) in narrow lateral peripheral 33 and 33′, bottom 34, top 34′ bands generally at least 0.5 mm in width. It is supplied through an electrical connection element 4 of the AMOLED screen 3 which comprises:
a flexible so-called connecting part 40 between the face F2 and the face F3 within the lamination interlayer with a front surface on the face F3 side and a rear surface on the face F2 side, of thickness E4 less than that E2 of the lamination interlayer, linked to the AMOLED screen and extending the AMOLED screen in the direction of the lip of the second glazing,
extended outside of the lip of the second glazing by a flexible so-called exterior part 45, curved and fixed by gluing on face F4 without stretching as far as the display zone 32′ via a part 47 terminated by its connector 8 in a zone accessible at the time of mounting/ dismantling.

The connection element 4 is a flexible printed circuit (FPC) suitable for the implementation of 2560×1600 pixels (AMOLED screen). The FPC 4 could also advantageously be of the same width as the AMOLED screen 3, so as to facilitate the insertion of the two elements into the lamination interlayer preferably of polyvinylbutyral (PVB set back a little with respect to the glazing edges). The interior glass 1′ comprises a notch 11′. The dimensions of the notch 11′ are suited to the FPC 4:
width of the notch 11′ greater than or equal to that of the FPC 4;
depth of the notch 11′ greater than or equal to the thickness of the FPC 4 preferably so as to prevent the FPC 4 being visible from the exterior in a case when the edge is evident.

In practice the depth of the notch 11′ lies between 1.5 mm and 2 mm. The zone of the notch 11′ is substantially devoid of lamination interlayer.

The tactile control zone 70 is under the bottom edge 34 in a transparent zone (neither exterior nor interior masking). Invisible means of tactile control (if restricted zone B) or optionally with a marker detailed hereinafter (away from restricted zone B: luminous, by design) are therefore favored.

The tactile control zone 70 comprises:
a transparent electroconducting layer (monolayer or multilayer) between the face F2 and the face F3 (on the face F2, on the face F3 or else on a transparent polymeric flexible support) for example covering at least 90% of the face F2 or F3 and serving as solar control layer and/or heating layer or else one or more sufficiently fine electroconducting wires between the face F2 and the face F3 (in the PVB)
or a locally transparent electroconducting layer on the face F4.

The first tactile control zone 70 comprises (functionally):
a first power supply switch 71 (optionally with a local marker: symbol etc) for turning the AMOLED screen 3 both on and off, notably a capacitive system, notably part insulated from the electroconducting solar control layer and/or heating layer by means of one or more insulating lines (cut trench-like, by laser ablation etc) that are as discreet as possible
a first navigation element 72 of the AMOLED screen 3 preferably with a first local marker such as an arrow for example oriented downwards for descending (from one zone) to another line (zone) of a (main or secondary) menu, of the AMOLED screen 3
a second navigation element 73 of the AMOLED screen 3 preferably with a second local marker such as an arrow for example oriented upwards for ascending from one line (of a zone) to another line (zone) of a (main or secondary) menu of the AMOLED screen 3
a third navigation element 74 of the AMOLED screen 3 preferably with a third local marker such as an arrow for example oriented toward the left for going from one line (of a zone) to another line (zone) of a (main or secondary) menu of the AMOLED screen 3,
a fourth navigation element 75 of the AMOLED screen 3 preferably with a fourth local marker such as an arrow for example oriented toward the left for going from one line (of a zone) to another line (zone) of a (main or secondary) menu of the AMOLED screen 3,
a fifth navigation element 75 of the AMOLED screen 3 preferably with a fifth local marker for changing the function of the AMOLED screen (telephone mode, alert mode etc).

Each local marker can be a white or black enamel or any other color on the face F3 or F4. The marker can also be a sticker on the face F4.

It is possible to place the tactile control zone in a distinct plane than the AMOLED screen. For example a supple flexible support bearing electrical conductors also exits through the notch 11′.

The tactile control zone 70 can be masked by masking layer on F3 or F4 notably of enamel.

The tactile control zone 70 can be connected preferably firmly to the edge 34 of the AMOLED screen.

FIG. 1′bis is a face-on and detail schematic view of a windshield 100′bis with AMOLED screen of an automotive vehicle, inside view. For simplicity the external masking layer is not represented although it covers the zone of the AMOLED screen (peripherally, opaque or slightly transparent). The solid-line elements are seen by transparency through the interior glazing 1′.

It differs from the windshield 100bis by its arrangement vertically.

The tactile control zone 70 comprises:
a transparent electroconducting layer (monolayer or multilayer) between the face F2 and the face F3 (on the face F2, on the face F3 or else on a transparent polymeric flexible support) for example covering at least 90% of the face F2 or F3 and serving as solar control layer and/or heating layer or else one or more sufficiently fine electroconducting wires between the face F2 and the face F3 (in the PVB)
or a locally transparent electroconducting layer on the face F4.

The tactile control zone 70 comprises (functionally):
a first power supply switch 71 (optionally with a local marker “ON”), notably a capacitive system, notably part-insulated from the electroconducting solar control layer and/or heating layer by means of one or more insulating lines (cut trench-like, by laser ablation etc) that are as discreet as possible
an optional second backup power supply switch 71′, notably a capacitive system, notably part-insulated from the electroconducting solar control layer and/or heating layer by means of one or more insulating lines (cut trench-like, by laser ablation etc) that are as discreet as possible
a first navigation element 72 of the AMOLED screen 3 preferably with a first local marker such as an arrow for example oriented downwards for descending from one line to another line of a (main or secondary) menu
a second navigation element 73 of the AMOLED screen 3 preferably with a second local marker such as an arrow for example oriented upwards for ascending from one line (of a zone) to another line (zone) of a (main or secondary) menu of the AMOLED screen 3.

FIG. 2 is a sectional and partial schematic view of a windshield 200 with AMOLED screen of an automotive vehicle, inside view.

The windshield 200 comprises:
a first glazing 1, with a first main face 11 termed F1, intended to be on the outside of the vehicle, and a second opposite main face 12 termed F2, preferably of thickness E1 of at most 2.5 mm, in particular a preferably tinted soda-lime-silica float glass sheet, with a 2.1 mm thickness of glass such as a TSA glass from the Applicant company
a lamination interlayer of polymeric substance 2, on the face F2 side, of thickness E2 preferably of at least 0.76 mm such as polyvinylbutyral (PVB)
a second glazing 1′, with a third main face 13 termed F3 on the lamination interlayer 2 side and a fourth opposite main face 14 termed F4, intended to be on the inside of the vehicle, preferably of thickness E′1 of at most 2.2 mm, in particular a soda-lime-silica float glass sheet with a 1.6 mm thickness of glass, for example tinted such as a TSA glass from the Applicant company,
between the face F2 and the face F3 and within the lamination interlayer, an organic light-emitting diode-based viewing screen, comprising a set of pixels, termed a flexible AMOLED screen 3, the AMOLED screen comprising a zone of dynamic information display 32′, of thickness E3 less than E2 and preferably subcentimetric, AMOLED screen having a front main face 32 oriented toward the face F3 and a rear face 31 oriented toward the face F2, the AMOLED screen is arranged peripherally,
within the lamination interlayer an electrical connection element 4 of the AMOLED screen.

The OLED screen 3 is therefore sandwiched between the exterior glass sheet 1 and the interior glass sheet 1′. It exhibits a display zone 32′ flanked by one or more technical edges (one, two, three or four) in narrow peripheral bands 34, 34′ generally at least 0.5 mm in width (and less than 1 cm preferably). The AMOLED screen 3, flexible and extended directly toward an edge of the glazing, by the connection element 4 which is linked to it and extends outside the lamination.

It is supplied through an electrical connection element 4 of the AMOLED screen 3 which comprises:
a flexible so-called connecting part 40 between the face F2 and the face F3 within the lamination interlayer with a front surface 42 on the face F3 side and a rear surface 41 on the face F2 side, of thickness E4 less than that E2 of the lamination interlayer linked to the AMOLED screen and extending the AMOLED screen in the direction of the lip of the second glazing 1′,
extended outside of the lip of the second glazing via a so-called exterior part 45 and curved and fixed by gluing (on face F4 without stretching as far as the display zone 32′ via a part 47 terminated by its connector 8 in a zone accessible at the time of mounting/ dismantling.

The connection element 4 is a flexible printed circuit (FPC) suitable for the implementation of 2560×1600 pixels (AMOLED screen). The FPC 4 could advantageously be of the same width as the AMOLED screen 3, so as to facilitate the insertion of the two elements into the lamination interlayer (set back a little with respect to the glazing edges).

The interior glass 1′ comprises a notch 11′. The dimensions of the notch 11′ are suited to the FPC 4:
width of the notch 11′ greater than or equal to that of the FPC 4;
depth of the notch 11′ greater than or equal to the thickness of the FPC 4 preferably so as to prevent the FPC 4 being visible from the exterior in a case when the edge is evident.

In practice the depth of the notch 11′ lies between 1.5 mm and 2 mm. The zone of the notch 11′ is substantially devoid of lamination interlayer.

The AMOLED screen 3 has for example a thickness E3. The connecting part 40 can be less thick. It is optionally covered or shrouded with any material so as to increase (if necessary) the thickness E4 thereof to a value substantially equal to E3. If E4 is equal of 0.4 mm, E3 is from 0.38 to 0.40 mm. A central ply 22 of 0.38 mm is for example used for the lamination, with a reserve to house the AMOLED screen and the connecting part and two external plies 22, 23 of 0.17 mm or 0.38 mm. One of the external plies can be thicker for example 0.76 mm.

It is possible to have more than 3 plies (if insertion of a polymeric film such as a PET etc) or for more mechanical protection.

When the AMOLED screen is at most 0.15 mm or even 0.2 mm in thickness, it is optionally possible to eliminate the central ply during assembly.

The first glazing (exterior) 1 comprises an external masking layer 5 on face F2, opaque, of black enamel preferably,
with an edge 51 toward the center of the windshield
and an edge 52 on the lip side of the glazing 15 for example at a distance of at most 3 or 1 mm from the lip 15.

It hides not only the glue bead 7′ of the trim 7″ but also the AMOLED screen 3 (opaque or slightly transparent), the connecting part 40 and the off-glazing part 45 of the FPC and the part 47 and its connector 8.

The external masking layer 5 is preferably a solid zone (a flat patch) rather than a network of patterns. Beyond the edge 51 it can be extended by a network of patterns (made of the same substance) for example in gradation over a width of at most 15 mm and even 5 mm and even larger if the lip 15 is the lower longitudinal edge.

The second glazing 1′ (interior) comprises on face F4 an internal masking layer 6 on face F4 (or as a variant F3), opaque, of black enamel preferably, with
an edge 61 toward the center of the windshield
an edge 65 on the notch side.

This internal masking layer 6 masks from the interior the entire surface of the connecting part 40 in particular that which is in the vision zone (away from zone with trim or optional casing). It can be wider than the connecting part.

This internal masking layer also masks from the interior the technical edges 34, 34′ of the AMOLED screen. It can protrude for example by at most 10 mm opposite the lamination interlayer over the perimeter of the technical edges in order to mask lamination defects.

When the internal masking layer 6 is thus on the perimeter of the AMOLED screen 3, an opening 63 has therefore been formed (masking or post fabrication of the layer) revealing the display zone 32′.

It can also protrude further beyond the technical edges so that its width is (almost equal) to that of the external masking layer 5 on either side of the AMOLED screen (and/or of the connecting part).

The internal masking layer 6 is preferably a solid zone (a flat patch) rather than a network of patterns. Beyond the edge 61 it can be extended by a network of patterns (made of the same substance) for example in gradation over a width of at most 15 mm and even 5 mm and even larger if the lip of the notch 11′ is the lower longitudinal edge.

The tactile control zone 70 is here offset from the AMOLED screen (at the bottom if AMOLED screen in top position). It protrudes (or not) beyond the edge of the internal masking 61.

A switch (away from restricted zone B) is for example described.

Behind the AMOLED screen 3 and the connecting part 40 is laminated a conducting film 95 which comprises a transparent flexible film such as a PET, PEN of thickness 10 μm to 1 mm, better 30 μm to 200 μm which carry the electrical conductors for example metallic (copper etc) emerging on the tactile control zone 70′ (of the same metal such as copper etc). The electrical conductors are for example in the form of metallic tracks (copper etc) 1 mm wide. The width of the switch 70 is for example 4 cm.

The width of the conducting film 95 can be greater than or equal to that of the AMOLED screen 3 or less (masked edges).

The conducting film 95 preferably protrudes beyond the lip 11′ so as to be connected to an external power supply (voltage for example from 12 to 15V or else 35V or 45 V) and/or an electronic control system (in particular CAN for “controller area network”).

As an example of switch design with power supply conductor it is possible to refer to the examples of patent applications W02009/050519 or W02015162107 (notably in conjunction with FIGS. 1B or 1C or 2A or even 3B) W02015162108 notably in conjunction with FIGS. 1B or 2A or even 3).

It is alternatively possible to use a metallic wire (curved into a circle at one end and even forming a spiral) for example of diameter 70 μm.

Alternatively the conducting wire is added on (against or glued to the face F2) or to the AMOLED screen and to the connecting part.

Alternatively this conducting film is offset from the AMOLED screen, alongside (spaced or adjoining) for example in the same plane (and even reduced to one and the same thickness) as the AMOLED screen. At the limit this may involve an extension of a technical edge 33.

FIG. 2a is a face-on and detail schematic view of a windshield with AMOLED screen of an automotive vehicle, inside view.

It illustrates the possible extent of the internal masking layer 6 on either side of the technical edges 33, 33′, 34, 34′ of the AMOLED screen here arranged horizontally along an upper longitudinal edge, in a central or non-central position.
lateral edges 64 and 64′ protruding preferably by at least 3 and even 20 mm and
bottom edge 61 protruding preferably by at least 3 mm.

It comprises a tactile control zone 70 integrated facade-like (transparent polymeric film such as a PET) of the AMOLED screen 3, over the entire display zone 32′ or of a portion of this zone. Alternatively or cumulatively two tactile control zones 70a and 70b are placed on either side of the AMOLED screen 3, control masked by the masking layer 6 on face F4.

The internal masking layer 6 is alternatively a strip of given width with an opening for the AMOLED screen,
strip along the upper or lower longitudinal edge, the AMOLED screen arranged horizontally being on the drivers and/or copilot's side
strip along the left or right lateral edge, the AMOLED screen arranged vertically on the drivers and/or copilot's side.

FIG. 2b is a face-on and detail schematic view of a windshield 200b with AMOLED screen of an automotive vehicle, inside view.

It differs from the windshield 200a by its arrangement vertically.

It comprises a tactile control zone 70 integrated facade-like (transparent polymeric film such as a PET) of the AMOLED screen 3 over the entire display zone 32′ or of a portion of this zone.

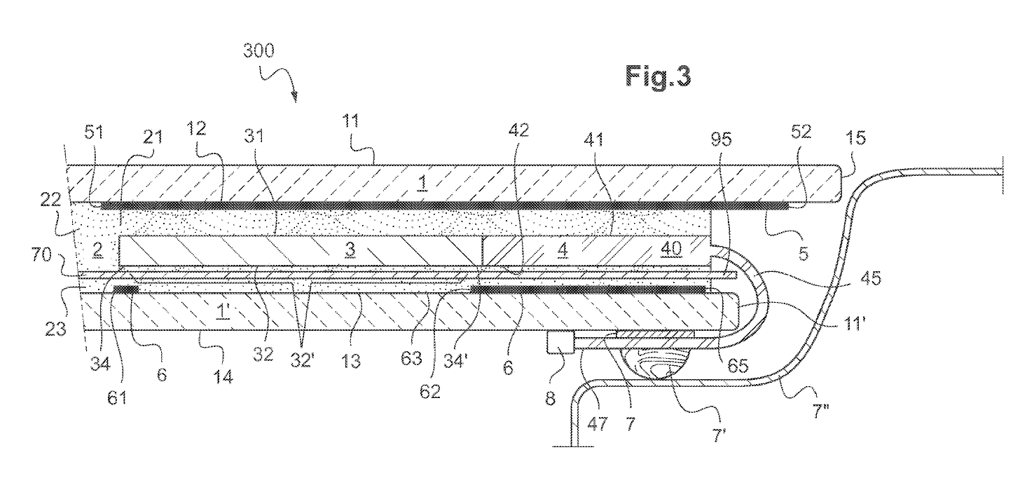

FIG. 3 is a sectional and partial schematic view of a windshield 300 with AMOLED screen of an automotive vehicle, inside view.

The windshield 300 differs from the windshield 200 firstly in that the internal masking layer is on face F3 instead of face F4.

It differs from the windshield 200 also in that the conducting film 95 is laminated on the front face side (between the face F3 and the front face and front surface 32,42). It is then preferably transparent (neutral in color etc).

This conducting film 95 can comprise a solid electroconducting layer (or electroconducting wires) having a solar control and/or heating function (demisting etc).

A zone for the tactile control zone and its power supply conductors is insulated via a separating line by laser ablation of the layer.

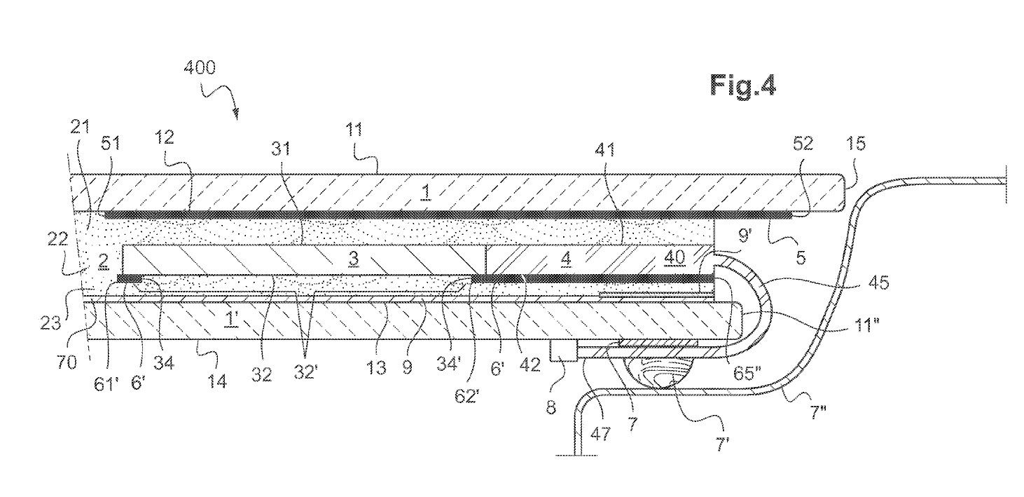

FIG. 4 is a sectional and partial schematic view of a windshield 400 with AMOLED screen of an automotive vehicle, inside view.

It differs from the windshield 200 in that the internal masking layer 6 is replaced with an opaque (opacified) film 6′ of polyethylene terephthalate (PET) that can be stuck to the whole of the AMOLED screen 3 and of the FPC 4 immediately when premounted with a view to its storage, or else form part of a film which has been stuck to this premounted assembly, from which film can then optionally be removed an undesired part precut before assembling the windshield.

The opaque film 6′ constitutes:
a masking of the FPC 40, opaque or slightly transparent, and of the junction between the PVB 22 (central part) and the AMOLED screen 3, which can comprise irregularities and flaws,
as well as a masking 61′, 62′ of the technical edges 34 of the AMOLED screen 3, seen from the interior side of the windshield.

The opaque film 6′ can also be an opacified extension of the transparent polymer material covering the AMOLED screen, that is to say be an integral part thereof.

The opaque film 6′ can also alternatively or cumulatively be an extension of the polymer material covering the FPC, that is to say be an integral part thereof.

Moreover, the face F3 is furnished with an electroconducting layer 9 and optionally with a current infeed 9′ for the latter; this layer can consist of a stack which reflects solar radiation, in silver or other, or with a heating coating/stack furnished for this purpose with its current infeed 9′. It can be covered directly with a masking of the technical edge of the AMOLED screen mentioned previously.

The electrocondcuting layer 9 comprises a zone insulated electrically by a separating line (laser ablation etc) so as to form the tactile control zone 70 and its power supply conductors.

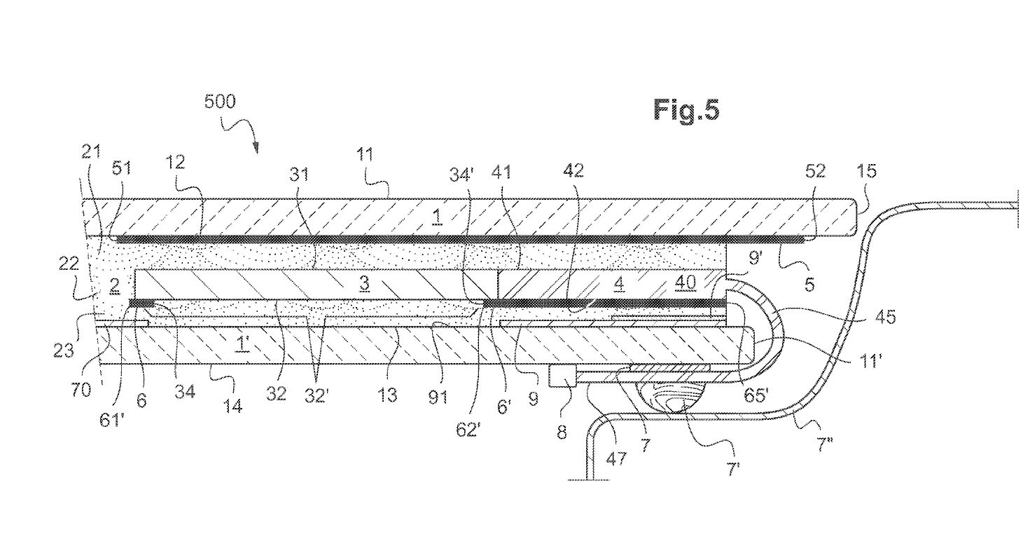

FIG. 5 is a sectional and partial schematic view of a windshield 500 with AMOLED screen of an automotive vehicle, inside view.

It differs from the previous windshield 400 in that for esthetic reasons the electroconducting layer is absent at least in the zone 91 opposite the display zone 32′.

The electroconducting layer 9 comprises a zone insulated electrically by a separating line (laser ablation etc) so as to form the tactile control zone 70 and its power supply conductors. Its power supply conductors then sidesteps the opening (L-shaped etc). Alternatively, the tactile control zone is made in the opening and preferably is invisible.

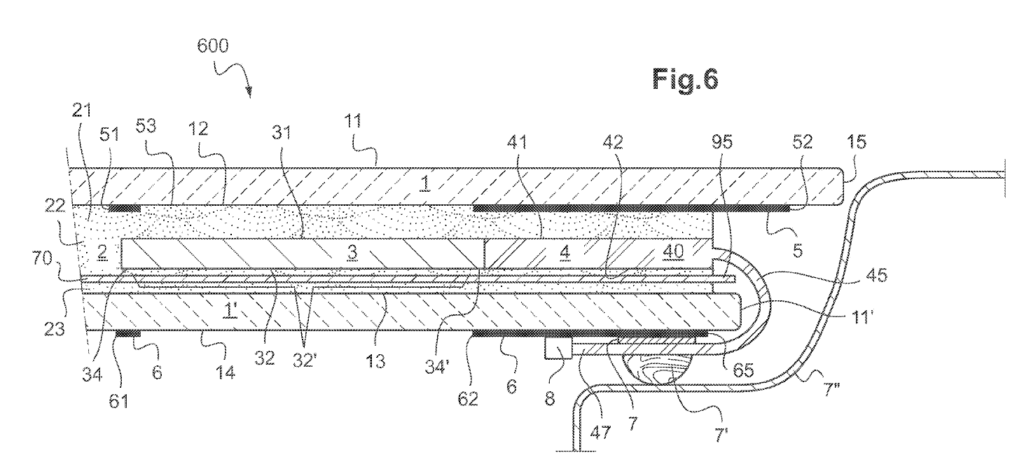

FIG. 6 is a sectional and partial schematic view of a windshield 600 with AMOLED screen of an automotive vehicle, inside view.

It differs from the windshield 200 in that the AMOLED screen 3 is placed in a transparent vision zone of which without external masking layer 6 behind.

However the masking of the exterior of the technical edges 34, 34′ (and even of the PVB 22) by the external enamel layer 5,51 can be accepted. Hence the enamel layer 5 can have an opening 53 facing the AMOLED screen zone. And the masking of the interior of the technical edges 34, 34′ (and even of the PVB 22) by the internal enamel layer 6,61 can be accepted. Hence the enamel layer 6 can have an opening 63 facing the AMOLED screen zone.

The tactile control zone 70 on a conducting film 95 is as detailed in FIG. 3 for the windshield 300.

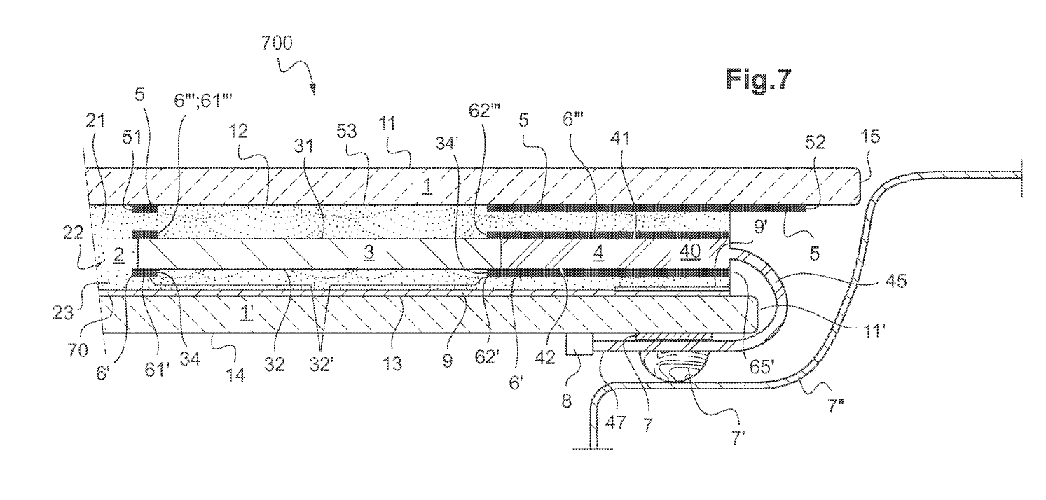

FIG. 7 is a sectional and partial schematic view of a windshield 700 with AMOLED screen of an automotive vehicle, inside view.

It differs from the windshield 600 by the replacement of the internal masking layer 6 by an opaque film 6′ (as in FIG. 5) on the AMOLED screen and the FPC 40 on the front side.

It is also possible an opaque film 6″ (as in FIG. 5) on the AMOLED screen and the FPC 40 on the rear side in addition to or as replacement for the enamel of the edge 51.

The tactile control zone 70 on the basis of an electroconducting layer 9 is as detailed in FIG. 4 for the windshield 400.

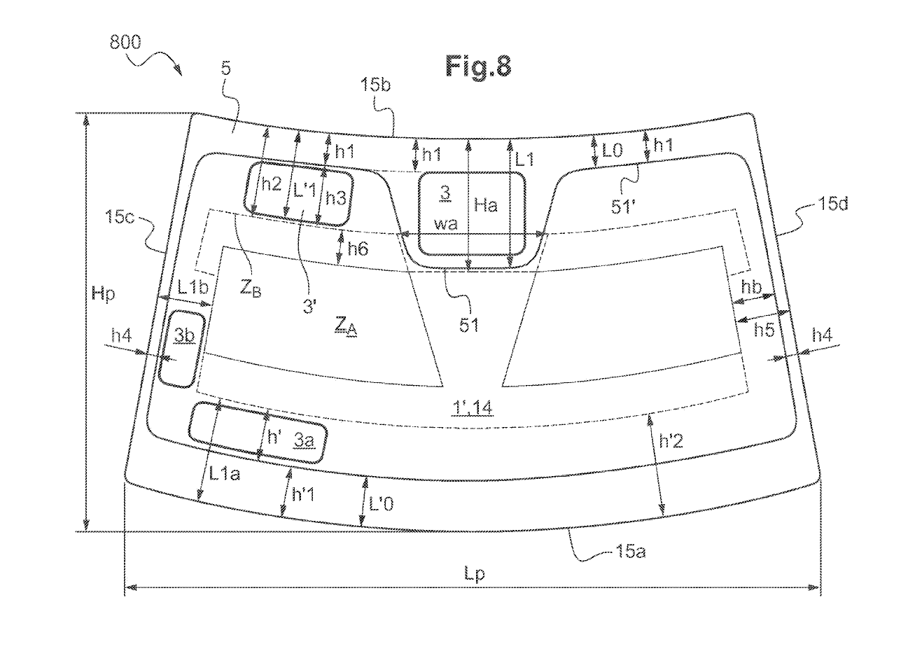

FIG. 8 is a face-on view of a road vehicle windshield which illustrates the possible peripheral zones for an opaque or slightly transparent or even very transparent AMOLED screen 3 (without rear masking) and shows the central transparent zone for a very transparent AMOLED screen 3.

This figure shows distances defining the limits of the vision zone of the driver (or copilot) and of the zone A Z_{A} or of the restricted zone B Z_{B}.

The following pairs of distances are defined:
h1 distance between the upper edge of the windshield and the upper limit F of the peripheral zone of vision of the driver or of the copilot in the vehicle, preferably of at least 15 mm and h2 distance between the upper edge and the upper limit F′ of the central zone of transparency on the driver's or copilot's side, of at least 120 mm, the AMOLED screen 3′ is between said limits F and F′ as well as preferably the optional other AMOLED screen(s) in this zone
h′1 distance between the lower edge of the windshield and the lower limit F1 of the peripheral zone of vision of the driver or of the copilot in the vehicle preferably of at least 40 mm and h′2 distance between the lower edge and the lower limit F′1 of the central transparency zone on the drivers or copilot's side of at least 120 mm, the AMOLED screen 3a is between said limits F1 and F′l as well as preferably the optional other AMOLED screen(s) in this zone
h4 distance between the lateral edge of the windshield and the lateral limit F2 of the peripheral zone of vision of the driver in the vehicle preferably of at least 15 mm and h5 distance between the lateral edge and the lateral limit F′2 of the central zone of transparency on the drivers side or the copilot's side of at least 80 mm, the AMOLED screen 3b is between said limits F2 and F′2 as well as preferably the optional other AMOLED screen(s) in this zone
h1 distance between the upper edge of the windshield and the upper limit F3 of the peripheral zone of vision of the driver or of the copilot in the vehicle, preferably of at least 15 mm and Hₐ distance between the upper edge and the upper limit F′3 of the central transparency zone in the central part, of at least 180 mm, the AMOLED screen is between said limits F3 and F′3 as well as preferably the optional other AMOLED screen(s) in this zone.

The enamel limits L1, L1, L1a, L1b can be respectively substantially equal to h2, Ha, h′2, h5 when the AMOLED screen is masked (opaque or slightly transparent especially).

As a variant the AMOLED screen is not masked from the rear (enamel strip less wide) in particular if very transparent.

Preferably the width of the top central zone wa is at most 300 mm.

The (automotive) road vehicle windshield of rectangular shape is:
from 1350 to 1550 mm in width (horizontal dimension) Lp.
from 950 to 1050 mm in height (vertical dimension) Hp.

By way of example we have h1=70 mm; h2=195 mm; h3=125 mm, Ha=270 mm; wa=300 mm; h6=75 mm; h4=25 mm; h5=125 mm; h′=85 mm; hb=100 mm.

1. A laminated vehicle glazing comprising:
a first glazing, with a first main face termed F1, to be oriented on the outside of the vehicle, and a second opposite main face termed F2, of thickness E1;
a lamination interlayer of polymeric substance, on the second main face side, of thickness E2;
a second glazing, with a third main face on the lamination interlayer side and a fourth opposite main face to be oriented on the inside of the vehicle, of thickness E′1, at least one of the first and second glazings being made of mineral glass,
between the second main face and the third main face, an organic light-emitting diode-based viewing screen, comprising a set of pixels, the organic light-emitting diode-based viewing screen comprising a zone of dynamic information display, the organic light-emitting diode-based viewing being of thickness E3 less than E2, the organic light-emitting diode-based viewing screen having a front main face oriented toward the third main face and a rear face oriented toward the second main face, the organic light-emitting diode-based viewing screen being covered by a non-zero thickness of lamination interlayer,
wherein the organic light-emitting diode-based viewing screen is flexible and the laminated glazing comprises an electroconducting structure comprising a tactile control zone, forming a switch of the organic light-emitting diode-based viewing screen and/or navigation element(s) of the organic light-emitting diode-based viewing screen, the tactile control zone being between the second main face and the third main face, covered by a non-zero thickness of lamination interlayer or being on the fourth main face.

2. The laminated vehicle glazing as claimed in claim 1, wherein the tactile control zone is in proximity to the organic light-emitting diode-based viewing screen and the tactile control zone is transparent and in a transparent zone of the glazing or wherein the tactile control zone is transparent or opaque, between the second main face and the third main face, optionally masked from the interior by an internal masking layer on the third main face or the fourth main face.

3. The laminated vehicle glazing as claimed in claim 1, wherein the tactile control zone is arranged:
for an upper or lower longitudinal reference edge, on one side of the organic light-emitting diode-based viewing screen,
or for an upper longitudinal reference edge, under a lower edge of the organic light-emitting diode-based viewing screen or for a lower longitudinal reference edge above an upper edge of the organic light-emitting diode-based viewing screen.

4. The laminated vehicle glazing as claimed in claim 1, wherein the tactile control zone is in proximity to the organic light-emitting diode-based viewing screen or sited away from the organic light-emitting diode-based viewing screen.

5. The laminated vehicle glazing as claimed in claim 1, wherein the tactile control zone is on the front face side of the organic light-emitting diode-based viewing screen, on or in the organic light-emitting diode-based viewing screen.

6. The laminated vehicle glazing as claimed in claim 1, wherein the tactile control zone comprises an electroconducting enamel layer on the second main face or on the third main face F3 or masked by the enamel internal masking layer on the fourth main face.

7. The laminated vehicle glazing as claimed in claim 1, wherein the tactile control zone comprises one or more electroconducting wires or the tactile control zone comprises an electroconducting layer which is:
on the fourth main face,
on the third main face, the electroconducting layer comprising an electrically insulated portion for the tactile control zone with the tactile control zone opposite the front face of the organic light-emitting diode-based viewing screen or offset from the organic light-emitting diode-based viewing screen, optionally the electroconducting layer is absent opposite the front face of the organic light-emitting diode-based viewing screen,
between the second main face and the rear face of the organic light-emitting diode-based viewing screen,
on the front face or spaced from the front face and between the front face of the organic light-emitting diode-based viewing screen and the third main face.

8. The laminated vehicle glazing as claimed in claim 7, wherein the electroconducting layer comprises a zone insulated electrically by at least one electric insulation track, and wherein the electroconducting layer is chosen from among:
a solar control layer on the third main face, and/or a heating layer
a solar control layer on a flexible polymeric film between the second main face and the third main face.

9. The laminated vehicle glazing as claimed in claim 1, wherein the electroconducting structure is a capacitive element.

10. The laminated vehicle glazing as claimed in claim 19, wherein the organic light-emitting diode-based viewing screen is transparent and in a clear window region or wherein the organic light-emitting diode-based viewing screen is masked by an external masking layer between the rear face of the organic light-emitting diode-based viewing screen and the second main face, and/or the electrical connection element is masked from the exterior by an external masking layer between the rear surface and the second main face.

11. The laminated vehicle glazing as claimed in claim 19, wherein the electrical connection element is masked from the exterior by an external masking layer between the rear surface and the second main face.

12. The laminated vehicle glazing as claimed in claim 19, wherein the electrical connection element, of thickness E4 substantially equal to E2 and of thickness E′4 less than E4 beyond a lip of the second glazing, is curved and is against or fixed by gluing on the fourth main face without stretching as far as the display zone.

13. The laminated vehicle glazing as claimed in claim 19, wherein the second glazing bears on the third main face or the fourth main face an internal masking layer arranged to mask from the interior:
technical edge or edges of the organic light-emitting diode-based viewing screen and optional other organic light-emitting diode-based viewing screen(s) that is or are adjacent or on distinct longitudinal edges,
and/or the electrical connection element or elements of the organic light-emitting diode-based viewing screen and optional other organic light-emitting diode-based viewing screen(s) that is or are adjacent or on distinct longitudinal edges,
or the technical edge or edges of the organic light-emitting diode-based viewing screen and of optional other organic light-emitting diode-based viewing screen(s) are masked by an interior masking element on the organic light-emitting diode-based viewing screen,
and/or the electrical connection element or elements are masked by said interior masking element or another adjacent one.

14. The laminated vehicle glazing as claimed in claim 1, wherein the organic light-emitting diode-based viewing screen and/or the connecting part has a thickness at most equal to 0.8 mm.

15. The laminated vehicle glazing as claimed in claim 1, comprising between the second main face and the fourth main face, an electroconducting layer or a set of electroconducting wires.

16. The laminated vehicle glazing as claimed in claim 1, wherein the organic light-emitting diode-based viewing screen covers at most an entire peripheral zone visible by the driver in the road vehicle windshield up to an edge of a transparent central vision zone.

17. (canceled)

18. The laminated vehicle glazing as claimed in claim 1, wherein the laminated vehicle glazing forms a windshield of a road vehicle, with the first and second glazing cambered.

19. The laminated vehicle glazing as claimed in claim 1, wherein the organic light-emitting diode-based viewing screen includes an electrical connection element, with a flexible connecting part between the second main face and the third main face with a front surface on the third main face side and a rear surface on the second main face side, the flexible connecting part being covered by a non-zero thickness of lamination interlayer, electrical connection element being of thickness E4 less than E2, linked to the organic light-emitting diode-based viewing screen and extending the organic light-emitting diode-based viewing screen in the direction of a lip of the second glazing, the, flexible, electrical connection element extending outside of the lip of the second glazing via an exterior part.

20. The laminated vehicle glazing as claimed in claim 15, wherein opposite the display zone, the electroconducting layer, or the set of electroconducting wires is absent.
